(19) United States
(12) Patent Application Publication
(10) Pub. No.: US 2026/0312760 A1
(43) Pub. Date: Oct. 8, 2026

(54) TERMINAL, RADIO COMMUNICATION METHOD, AND BASE STATION

(71) Applicant: NTT DOCOMO, INC., Tokyo (JP)

(72) Inventors: Naoya SHIBAIKE, Tokyo (JP); Yuki MATSUMURA, Tokyo (JP); Satoshi NAGATA, Tokyo (JP); Jing WANG, Beijing (CN)

(73) Assignee: NTT DOCOMO, INC., Tokyo (JP)

(21) Appl. No.: 19/481,584

(22) PCT Filed: May 12, 2023
(86) PCT No.: PCT/JP2023/017999

§ 371 Date: Nov. 5, 2025

(51) Int. Cl. H04L 5/00; H04W 72/044

(52) U.S. Cl. CPC H04L 5/0051; H04L 5/0042; H04W 72/044

(57) ABSTRACT

A terminal according to one aspect of the present disclosure includes a receiving section that receives information related to sounding reference signal (SRS) transmission using a plurality of ports being more than four ports, and a control section that determines, based on the information, at least one of a number of repetitions of the SRS transmission, a number of symbols to which the plurality of ports are mapped, and a number of ports out of the plurality of ports to be mapped to one symbol.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). For the purpose of further high capacity, advancement and the like of the LTE (Third Generation Partnership Project (3GPP (registered trademark)) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

In 3GPP Rel. 15/16, a maximum number of UL layers is 4, and a maximum number of sounding reference signal (SRS) ports is also 4. Thus, UL transmission is implemented using simple relationships between the layers and the uplink (UL) channel/signal (PUSCH/SRS) ports.

In future radio communication systems (for example, 3GPP Rel. 18 or later versions), supporting more than four layers in UL transmission from a terminal (a user terminal, a User Equipment (UE)) has been under study. However, various configurations and the like in a case of supporting SRS ports having more than four ports have not been made clear. For example, transmission power control for an SRS has not been made clear. Consequently, transmission of the SRS using more than four SRS ports may not be appropriately performed.

In view of this, the present disclosure has one object to provide a terminal, a radio communication method, and a base station in which transmission of an SRS using more than four SRS ports can be appropriately performed.

### Solution to Problem

A terminal according to one aspect of the present disclosure includes a receiving section that receives information related to sounding reference signal (SRS) transmission using a plurality of ports being more than four ports, and a control section that determines, based on the information, at least one of a number of repetitions of the SRS transmission, a number of symbols to which the plurality of ports are mapped, and a number of ports out of the plurality of ports to be mapped to one symbol.

### Advantageous Effects of Invention

According to one aspect of the present disclosure, transmission of an SRS using more than four SRS ports can be appropriately performed.

### BRIEF DESCRIPTION OF DRAWINGS

FIG. 1 shows an example of an SRS resource set configuration information element.

FIG. 2 shows an example of an SRS resource configuration information element.

FIG. 3 shows an example of an association of parameters related to an SRS.

FIG. 4 shows an example of an SRS frequency hopping band.

FIG. 5 shows an example of SRS frequency hopping.

FIG. 6 shows another example of SRS frequency hopping.

FIG. 7 shows an example of a table showing a relationship between a transmission comb number K_{TC} and a maximum number of cyclic shifts n_{SRS}^{CS,max} of an SRS in Rel. 16.

FIG. 8 shows an example of a table showing the transmission comb number K_{TC} and a cyclic shift value n_{SRS}^{CS,i} of the SRS when the number of SRS ports Nₐₚ^{SRS} is 2.

FIG. 9 shows an example of a table showing the transmission comb number K_{TC} and the cyclic shift value n_{SRS}^{CS,i} of the SRS when the number of SRS ports Nₐₚ^{SRS} is 4.

FIG. 10 shows an example of port distribution to which TDM is applied.

FIG. 11 shows an example of a power amplifier circuit in a UE.

FIG. 12 shows an example of SRS transmission power for each port in a plurality of cases.

FIG. 13 shows an example of Embodiment A5.

FIG. 14 shows an example of an 8-port SRS to be subjected to TDM.

FIG. 15A to FIG. 15C show examples of SRS repetition and intra-slot frequency hopping.

FIG. 16A and FIG. 16B show examples of option 1 of Embodiment 4.

FIG. 17 is a diagram to show an example of a schematic structure of a radio communication system according to one embodiment.

FIG. 18 is a diagram to show an example of a structure of a base station according to one embodiment.

FIG. 19 is a diagram to show an example of a structure of a user terminal according to one embodiment.

FIG. 20 is a diagram to show an example of a hardware structure of the base station and the user terminal according to one embodiment.

FIG. 21 is a diagram to show an example of a vehicle according to one embodiment.

### DESCRIPTION OF EMBODIMENTS

### (SRS)

In NR, there are various usages of a sounding reference signal (SRS). The SRS in NR is used not only for uplink (UL) CSI measurement that is also used in existing LTE (LTE Rel. 8 to Rel. 14), but is used also for downlink (DL) CSI measurement, beam management, and the like.

A UE may be configured with one or a plurality of SRS resources. Each SRS resource may be identified with an SRS resource index (SRI).

Each SRS resource may include one or a plurality of SRS ports (may correspond to one or a plurality of SRS ports). For example, the number of ports for each SRS may be 1, 2, 4, or the like.

The UE may be configured with one or a plurality of SRS resource sets. One SRS resource set may be associated with a certain number of SRS resources. The UE may use a common higher layer parameter for the SRS resources included in one SRS resource set. Note that the resource set in the present disclosure may be interpreted as a set, a resource group, a group, or the like.

Information related to the SRS resource or the resource set may be configured for the UE, using higher layer signaling, physical layer signaling, or a combination of these.

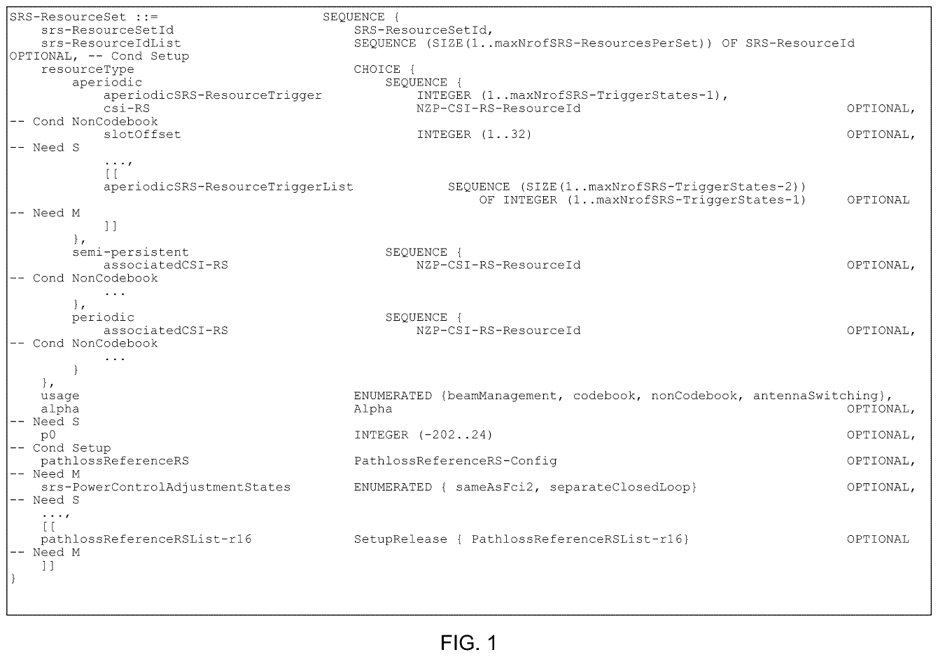

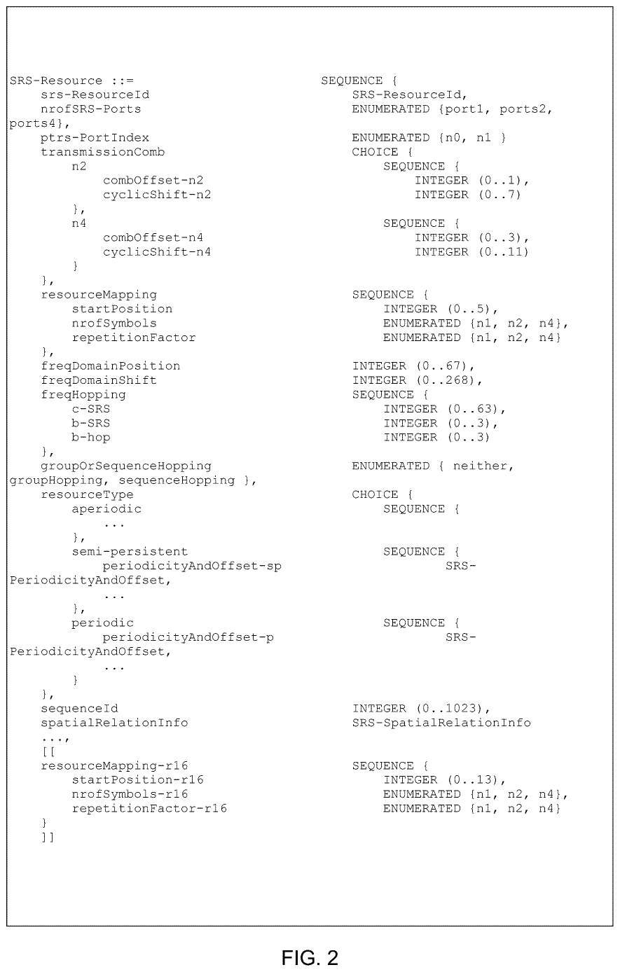

An SRS configuration information element (for example, an RRC information element “SRS-Config”) may include an SRS resource set configuration information element (FIG. 1), an SRS resource configuration information element (FIG. 2), and the like.

The SRS resource set configuration information element (for example, an RRC parameter “SRS-ResourceSet”) may include pieces of information of an SRS resource set ID (Identifier) (SRS-ResourceSetId), a list of SRS resource IDs (SRS-ResourceId) used in the resource set, an SRS resource type (resourceType), and a usage of the SRS.

Here, the SRS resource type may indicate a time domain behavior (same time domain behavior) of an SRS resource configuration, or may indicate any one of a periodic SRS or a P-SRS, a semi-persistent SRS or an SP-SRS, and an aperiodic SRS, an A-SRS, or an AP-SRS. Note that the UE may transmit the P-SRS and the SP-SRS periodically (or periodically after activation). The UE may transmit the A-SRS, based on an SRS request on DCI.

The usage of the SRS (an RRC parameter “usage”, an L1 (Layer-1) parameter “SRS-SetUse”) may be, for example, beam management (beamManagement), a codebook (CB), a non-codebook (NCB), antenna switching (antennaSwitching), or the like. For example, the SRS having the usage of the codebook or the non-codebook may be used for determination of a precoder for codebook based or non-codebook based uplink shared channel (Physical Uplink Shared Channel (PUSCH)) transmission based on the SRI.

For the SRS having the usage of beam management, it may be assumed that only one SRS resource in each SRS resource set can be transmitted in a certain time instant (given time instant). Note that, in the same Bandwidth Part (BWP), when a plurality of SRS resources corresponding to the same time domain behavior respectively belong to different SRS resource sets, these SRS resources may be simultaneously transmitted.

The SRS resource configuration information element (for example, an RRC parameter “SRS-Resource”) may include an SRS resource ID (SRS-ResourceId), the number of SRS ports, an SRS port number, a transmission comb number, SRS resource mapping (for example, a time and/or frequency resource position, a resource offset, periodicity of the resources, the number of repetitions, the number of SRS symbols, an SRS bandwidth, or the like), hopping related information, an SRS resource type, a sequence ID, spatial relation information, and the like.

A value of the transmission comb number (transmissionComb) is {2, 4}. A value of the number of SRS ports (nrofSRS-Ports) Nₐₚ^{SRS} is {1, 2, 4}. A value of an antenna port number pᵢ is {1000, 1001, . . . }. A value of the number of SRS consecutive OFDM symbols (nrofSymbols) N_{symb}^{SRS} is {1, 2, 4}. For a starting position (startPosition) in the time domain, an offset l_{offset} of the symbols that can be counted backwards in a time domain direction from the end of a slot is {0, 1, . . . 5}, and the starting position is given by l₀=N_{symb}^{slot}−1−l_{offset}.

A configuration of the transmission comb number may include a comb offset and a cyclic shift (a cyclic shift (CS) index, a CS number).

The SRS from the UE in which at least one of the comb offset (subcarrier offset)={0, 1, . . . . K_{TC}−1} and the CS is different may be multiplexed using the same transmission comb number, the same RB, and the same symbol.

The UE may switch Bandwidth Parts (BWPs) for transmitting the SRS for each slot, or may switch antennas. The UE may apply at least one of intra-slot hopping and inter-slot hopping to SRS transmission.

In an existing SRS, a frequency domain starting position k₀^{p_i} for pᵢ (p_i) is given by the following calculation expression.

$${k}_{0}^{p\_i} = {k}_{0}^{- p\_i} + {\sum }_{b = 0}^{BSRS} {K}_{TC} {M}_{SC , b}^{SRS} {n}_{b}$$

Here, k⁻ indicates a variable with an overline placed over k, and may also be referred to as k-bar. k⁻₀^{p_i} may be based on a comb offset K⁻_{TC}. K_{TC} is a transmission comb number. M_{SC,b}^{SRS} is the number of subcarriers used for SRS transmission out of an SRS bandwidth m_{SRS,b} [RB]. n_{b} is a constant.

### (SRS Bandwidth Configuration)

In Rel-16 specifications, the SRS bandwidth is defined. C_{SRS} ∈{0, . . . , 63} (configuration index, row index) and B_{SRS}∈{0, 1, 2, 3} (number of boundaries of band division) are configured using higher layer signaling, and the SRS bandwidth is determined using a table (association/mapping of parameters related to the SRS) defined in a specification.

An available bandwidth is divided into some parts, using B_{SRS}. A plurality of parts are used for SRS hopping. C_{SRS} configures a set of SRS bands. With B_{SRS}, one bandwidth in the configured set is selected. The present example shows a case in which C_{SRS}=13. All of candidate values of the SRS bandwidth m_{SRS,b} (number of RBs) are a multiple of 4. B_{SRS} is used to divide an available bandwidth into a plurality of parts. As B_{SRS} is larger, the number of frequency sections is larger (the size of each frequency section is smaller).

For SRS frequency hopping, a parameter bₕₒₚ∈{0, 1, 2, 3} is configured. When bₕₒₚ<B_{SRS}, SRS frequency hopping is enabled. The SRS is transmitted using an SRS band out of bands (hopping bands) given for SRS frequency hopping.

Among bands (hopping bands) given for SRS frequency hopping, the SRS having the SRS band m_{SRS,b} is transmitted. For example, when C_{SRS}=24, bₕₒₚ=0, B_{SRS}=2, and N_{symb}^{SRS}=4, m_{SRS,b} is 24 RBs.

### (SRS Antenna Switching)

In Rel-15 NR, as described above, antenna switching (which may be referred to as antenna port switching) can be configured as a usage of the SRS. SRS antenna switching may be used to perform downlink CSI acquisition in a time division duplex (TDD) band, using an uplink SRS, for example.

For example, for the UE having a capability that the number of antenna ports available for transmission is less than the number of antenna ports available for reception, UL SRS measurement may be used in order to determine a DL precoder.

Note that the UE may report, to a network, UE capability information (for example, an RRC parameter “supportedSRS-TxPortSwitch”) indicating a transmission port switching pattern of the supported SRS. The pattern may be expressed in a format of “txry”, such as “t1r2” and “t2r4”, for example, and this may mean that SRS transmission can be performed using x antenna ports out of a total of y antennas (which may be expressed as xTyR). Here, y may correspond to all of or a subset of receive antennas of the UE.

For example, for DL CSI acquisition, the UE of 2T4R (2 transmission ports, 4 reception ports) may include two SRS resources each including two ports, and may be configured with the SRS resource set having the usage of antenna switching.

Note that, when x and y in “txty” have the same value, it may be expressed as xT=xR (for example, 4T=4R).

### (Multi-Port SRS Transmission)

Multi-port SRS transmission will be described. When multi-port SRS transmission is performed, the UE performs multiplexing using a cyclic shift of a base sequence. The following expression shows a cyclic shift αᵢ in an antenna port Pᵢ.

$${α}_{i} = 2 π \frac{{n}_{SRS}^{CS , i}}{{n}_{SRS}^{CS , max}} , \qquad ( A1 )$$

$$where :$$

$${n}_{SRS}^{CS , i} = \{ \begin{matrix}( {n}_{SRS}^{CS} + \frac{{n}_{SRS}^{CS , max} ⌊ \frac{{p}_{i} - 1000}{2} ⌋}{{N}_{ap}^{SRS} / 2} ) mod {n}_{SRS}^{CS , max} & \\ if {N}_{ap}^{SRS} = 4 and {n}_{SRS}^{CS , max} = 6 , & \\ ( {n}_{SRS}^{CS , i} + \frac{{n}_{SRS}^{CS , max} ( {p}_{i} - 1000 )}{{N}_{ap}^{SRS}} ) mod {n}_{SRS}^{CS , max} & otherwise\end{matrix}$$

It has been under study that the expression is used in Rel. 17. In the expression, a case in which the number of ports Nₐₚ^{SRS} is 4 and a maximum number of cyclic shifts n_{SRS}^{CS,max} is 6 is defined as case 1, and a case other than that (otherwise) is defined as case 2. In case 1, the transmission comb number K_{TC} is 8.

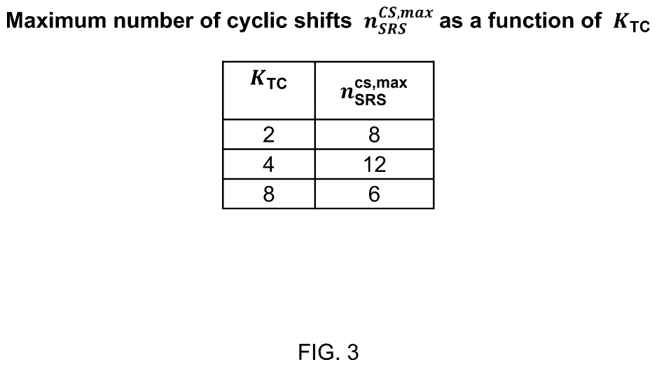

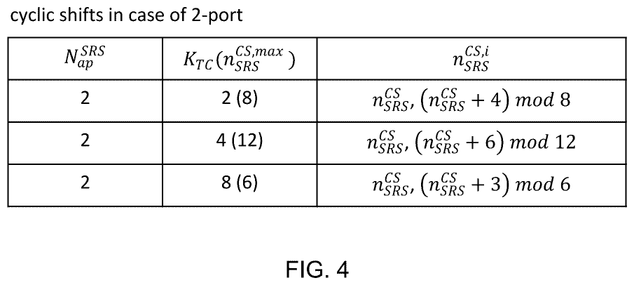

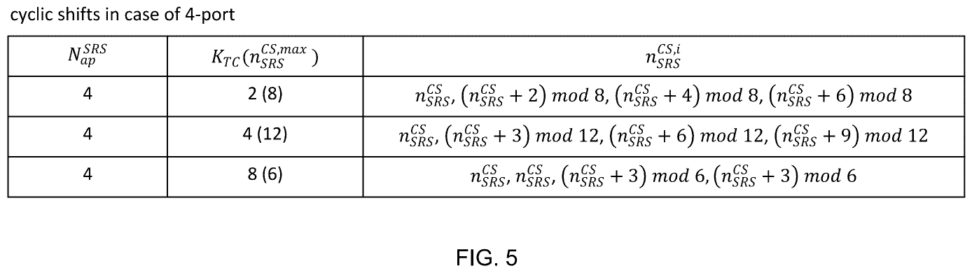

FIG. 3 is a table to show a relationship between the transmission comb number K_{TC} and the maximum number of cyclic shifts n_{SRS}^{CS,max} of the SRS in Rel. 16. Note that n_{SRS}^{CS,max}∈{0, 1, . . . , N_{SRS}^{CS,max}} and Nₐₚ^{SRS} ∈{1, 2, 4}. FIG. 4 is a table to show the transmission comb number K_{TC} and a cyclic shift value n_{SRS}^{CS},i of the SRS when the number of SRS ports Nₐₚ^{SRS} is 2. FIG. 5 is a table to show the transmission comb number K_{TC} and the cyclic shift value N_{SRS}^{CS,i} of the SRS when the number of SRS ports Nₐₚ^{SRS} is 4.

The following expression shows the resource starting position k₀^{p_i} in the frequency direction.

$${k}_{0}^{{p}_{i}} = {\overline{k}}_{0}^{{p}_{i}} + {n}_{offset}^{FH} + {n}_{offset}^{RPFS} , \qquad ( A2 )$$

$$where :$$

$${\overline{k}}_{0}^{{p}_{i}} = {n}_{shift} {n}_{SC}^{RB} + ( {k}_{TC}^{{p}_{i}} + {k}_{offset}^{{l}^{′}} ) mod {K}_{TC}$$

$${k}_{TC}^{{p}_{i}} = \{ \begin{matrix}( {\overline{k}}_{TC} + {K}_{TC} / 2 ) mod {K}_{TC} \\ if {N}_{ap}^{SRS} = 4 , {p}_{i} ∈ \{ 1001 , 1003 \} and {n}_{SRS}^{CS , max} = 6 , \\ ( {\overline{k}}_{TC} + {K}_{TC} / 2 ) mod {K}_{TC} \\ \begin{matrix}if {N}_{ap}^{SRS} = 4 , {p}_{i} ∈ \{ 1001 , 1003 \} and \\ {n}_{SRS}^{CS , max} = ∈ \{ {n}_{SRS}^{cs , max} / 2 , … , {n}_{SRS}^{cs , max} - 1 \} ,\end{matrix} \\ \begin{matrix}{\overline{k}}_{TC} & otherwise\end{matrix}\end{matrix}$$

$${k}_{offset}^{{l}^{′}} \text{:} Positioning specific offset$$

$${n}_{offset}^{FH} = {\sum }_{b = 0}^{{B}_{SRS}} {m}_{SRS , b} {n}_{SC}^{RB} {n}_{b}$$

$${n}_{offset}^{RPFS} = {n}_{SC}^{RB} {m}_{SRS , {B}_{SRS}} ( ( {k}_{F} + {k}_{hop} ) mod {P}_{F} ) / {P}_{F}$$

It has been under study that the expression is used in Rel. 17. Note that, regarding three cases of k⁻_{TC}^{p_i}, first case A corresponds to odd-numbered ports {1001, 1003} when the transmission comb number is 8. Second case B corresponds to odd-numbered ports {1001, 1003} having average or more cyclic shift values (nₐₚ^{CS}=∈{n_{SRS}^{CS,max}/2, . . . , n_{SRS}^{CS,max}}) when the transmission comb number is 2 or 4. Third case C is a case other than the above.

nshift is configured with a parameter freqDomainShift of the SRS resource configuration information element (FIG. 2). For k⁻_{TC}, combOffset of the SRS resource configuration information element is used. K_{TC} is configured with transmissionComb of the SRS resource configuration information element. In other words, in case C, values of RRC parameters are applied as they are.

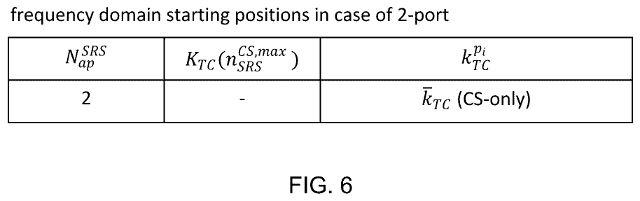

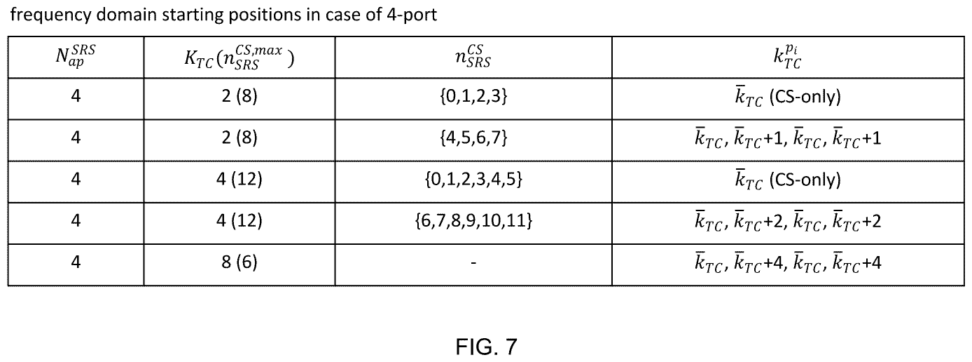

FIG. 6 shows the resource starting position k_{TC}^{p_i} in the frequency direction when the number of SRS ports Nₐₚ^{SRS} is 2. In the present example, case C is used. FIG. 7 shows the resource starting position k₀^{p_i} in the frequency direction when the number of SRS ports Nₐₚ^{SRS} is 4. In the present example, case C is applied in a first or third row (a case of (n_{SRS}^{CS})={0, 1, 2, 3} or {0, 1, 2, 3, 4, 5}), case B is applied in a second or fourth row (a case of (n_{SRS}^{CS})={4, 5, 6, 7} or {6, 7, 8, 9, 10, 11}), and case A is applied in a fifth row (a case of K_{TC} (N_{SRS}^{CS,max})=8 (6)).

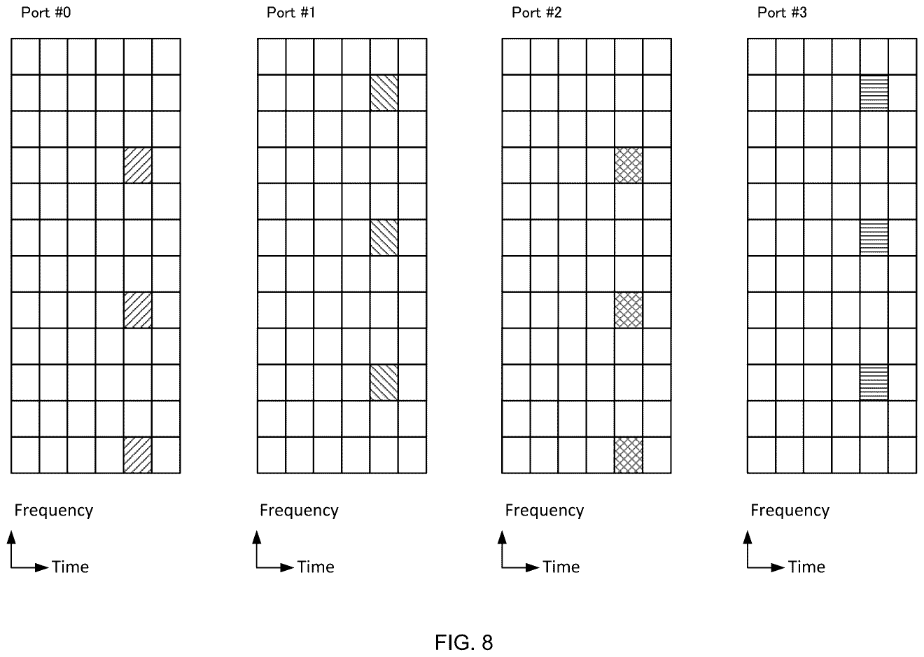

FIG. 8 shows SRS allocation in each port when the transmission comb number is 4. Case C is used in ports #0 and 2 of the present example, and case B is used in ports #1 and 3. In each port, different cyclic shifts are used. Note that, in FIG. 8, the horizontal axis represents time (symbols) and the vertical axis represents frequency (subcarriers). The same holds true for other figures showing SRS allocations.

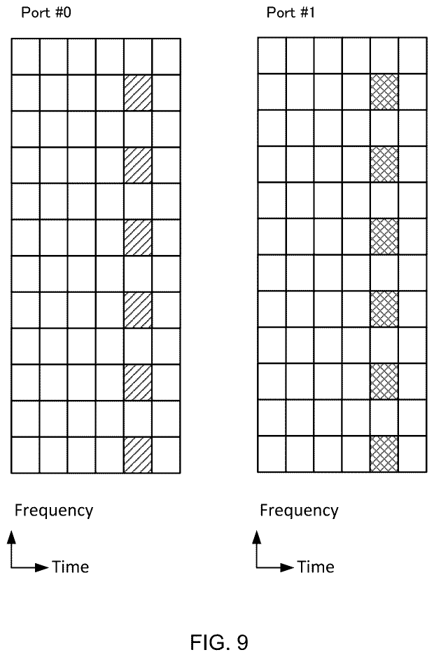

FIG. 9 shows SRS allocation in each port when the transmission comb number is 2. Case C is used in ports #0 and 1 of the present example. In each port, different cyclic shifts are used.

### (Base Sequence)

The base sequence of the SRS is given by the following expression.

$${r}^{( {p}_{i} )} ( n , {l}^{′} ) = {r}_{u , v}^{( {α}_{i} , δ )} ( n ) \qquad ( B1 )$$

$$0 \leq n \leq {M}_{sc , b}^{SRS} ( n ) - 1$$

$${l}^{′} ∈ \{ 0 , 1 , … , {N}_{symb}^{SRS} - 1 \}$$

$${r}_{u , v}^{( {α}_{i} , δ )} ( n ) = {e}^{j α n} {\overline{r}}_{u , v} ( n ) , \qquad 0 \leq n \leq {M}_{ZC}$$

At least one of sequence hopping and group hopping for a low PAPR sequence may be configured by RRC. A base sequence r⁻_{u,v}(n) is divided into a plurality of groups. r⁻ indicates a variable with an overline placed over r, and may also be referred to as r-bar. u={0, 1, . . . , 29} represents a group number, and v represents a base sequence number in a group. Each group includes one base sequence (v=0) having a length of mM_{ZC}=N_{sc}^{RB}/2^{δ}, where ½≤m/2^{δ}≤5, and two base sequences (v=0, 1) having a length of mM_{ZC}=N_{sc}^{RB}/2^{δ}, where 6≤m/2^{δ}. Definition of the base sequences r⁻_{u,v}(0), . . . , r⁻_{u,v}(M_{ZC}−1) depends upon the sequence length M_{ZC}.

In group hopping, the group number u is given by the following expression, based on an SRS sequence ID n_{ID}^{SRS} and a symbol number in a radio frame for SRS resources.

$$u = ( {f}_{gh} ( {n}_{s , f}^{μ} , {l}^{′} ) + {n}_{ID}^{SRS} ) mod 30 \qquad ( C1 )$$

The symbol number is based on a slot number n_{s,f}^{μ} in a radio frame, the number of symbols N_{symb}^{slot} in a slot, a start symbol l₀ for the SRS resources, and an SRS symbol number l′∈{0, 1, . . . , N_{symb}^{SRS}−1} in the SRS resources. N_{ID}^{SRS}∈{0, 1, . . . , 1023} is given by a higher layer parameter sequenceId in an SRS-Resource IE, or N_{ID}^{SRS}∈{0, 1, . . . , 65535} is given by a higher layer parameter sequenceId in an SRS-PosResource-r16 IE.

When groupOrSequenceHopping is equal to ‘neither’, neither group hopping nor sequence hopping is used. In this case, the group number u and the sequence number v are given by the following expression.

$${f}_{gh} ( {n}_{s , f}^{μ} , {l}^{′} ) = 0 \qquad ( C2 )$$

$$v = 0$$

When groupOrSequenceHopping is equal to ‘groupHopping’, group hopping is used and sequence hopping is not used. In this case, the group number u and the sequence number v are given by the following expression.

$${f}_{gh} ( {n}_{s , f}^{μ} , {l}^{′} ) = ( {\sum }_{m = 0}^{7} c ( 8 ( {n}_{s , f}^{μ} {N}_{symb}^{slot} + {l}_{0} + {l}^{′} ) + m ) \cdot {2}^{m} ) mod 30 \qquad ( C3 )$$

$$v = 0$$

Here, at the start of each radio frame, a pseudo-random sequence c(i) is initialized by cᵢₙᵢₜ=n_{ID}^{SRS}.

When groupOrSequenceHopping is equal to ‘sequenceHopping’, sequence hopping is used and group hopping is not used. In this case, the group number u and the sequence number v are given by the following expression.

$${f}_{gh} ( {n}_{s , f}^{μ} , {l}^{′} ) = 0 \qquad ( C4 )$$

$$v = \{ \begin{matrix}c ( {n}_{s , f}^{μ} {N}_{symb}^{slot} + {l}_{0} + {l}^{′} ) & {M}_{sc , b}^{SRS} \geq 6 {N}_{sc}^{RB} \\ 0 & otherwise\end{matrix}$$

Here, at the start of each radio frame, a pseudo-random sequence c(i) is initialized by cᵢₙᵢₜ=n_{ID}^{SRS}.

### (SRS Transmission Power Control)

Using an index l of a power control adjustment state (closed loop state), transmission power (P_{SRS,b,f,c}(i, qₛ, l)) of the SRS in an SRS transmission occasion (also referred to as a transmission period or the like) i regarding an active UL BWP b of a carrier f of a serving cell c is given by the following expression, based on P_{CMAX,f,c}(i), P_{O_SRS,b,f,c}(qₛ), M_{SRS,b,f,c}(i), α_{SRS,b,f,c}(qₛ), PL_{b,f,c}(q_{d}), and h_{b,f,c}(i, l).

$$( 1 )$$

$${P}_{SRS , b , f , c} ( i , {q}_{s} , l ) = min \{ \begin{matrix}{P}_{CMAX , f , c} ( i ) , \\ \begin{matrix}{P}_{O \_ SRS , b , f , c} ( {q}_{s} ) + 10 {log}_{10} ( {2}^{μ} \cdot {M}_{SRS , b , f , c} ( i ) ) + \\ {α}_{SRS , b , f , c} ( {q}_{s} ) \cdot {PL}_{b , f , c} ( {q}_{d} ) + {h}_{b , f , c} ( i , l )\end{matrix}\end{matrix} \} [ dBm ]$$

The SRS transmission occasion i is a period in which the SRS is transmitted, and may include, for example, one or more symbols, one or more slots, or the like.

Here, P_{CMAX,f,c}(i) is, for example, UE maximum output power for the carrier f of the serving cell c in the SRS transmission occasion i. P_{O_SRS,b,f,c}(qₛ) is a parameter related to target received power provided by p0 for the active UL BWP b of the carrier f of the serving cell c and an RS resource set qₛ (provided by SRS-ResourceSet and SRS-ResourceSetId) (also referred to as, for example, a parameter related to a transmission power offset, a transmission power offset P0, a target received power parameter, or the like).

M_{SRS,b,f,c}(i) is an SRS bandwidth represented by the number of resource blocks for the SRS transmission occasion i on the active UL BWP b of the carrier f of the serving cell c and the subcarrier spacing μ.

α_{SRS,b,f,c}(qₛ) is provided by a (for example, alpha) for the active UL BWP b of the carrier f of the serving cell c and the subcarrier spacing μ and the SRS resource set qₛ.

PL_{b,f,c}(q_{d}) is a DL path loss estimation value [dB] (path loss estimation [dB], path loss compensation) calculated by the UE using the RS resource index q_{d} for the active DL BWP of the serving cell c and the SRS resource set qₛ. The RS resource index q_{d} is a path loss reference RS (an RS for path loss reference, a pathloss (PL)-RS, or a DL-RS for path loss measurement, which is provided by pathlossReferenceRS, for example) associated with the SRS resource set qₛ, and is an SS/PBCH block index (for example, ssb-Index) or a CSI-RS resource index (for example, csi-RS-Index).

If the UE is not given the path loss reference RS (pathlossReferenceRSs) or before the UE is given a dedicated higher layer parameter, the UE calculates PL_{b,f,c}(q_{d}) using an RS resource obtained from an SS/PBCH block used by the UE to acquire an MIB.

h_{b,f,c}(i, l) is an SRS power control adjustment state for the active UL BWP of the carrier f of the serving cell c in the SRS transmission occasion i. When a configuration of the SRS power control adjustment state (for example, srs-PowerControlAdjustmentStates) indicates the same power control adjustment state for SRS transmission and PUSCH transmission, it is the current PUSCH power control adjustment state f_{b,f,c}(i, l). On the other hand, when the configuration of the SRS power control adjustment state indicates an independent power control adjustment state for SRS transmission and PUSCH transmission, the SRS power control adjustment state h_{b,f,c}(i) may be based on δ_{SRS,b,f,c}(m).

When TPC accumulation is enabled, h_{b,f,c}(i) may be based on an accumulated value of δ_{SRS,b,f,c}(m).

When TPC accumulation is disabled, h_{b,f,c}(i) may be δ_{SRS,b,f,c}(i) (absolute value).

Here, δ_{SRS,b,f,c}(m) may be a TPC command value coded by being combined with another TPC command in the PDCCH having DCI (for example, DCI format 2_3). Σₘ₌₀^{C(Si)-1}δ_{SRS,b,f,c}(m) may be a sum of TPC commands in a set Sᵢ of TPC command values having cardinality C (Sᵢ) received by the UE between K_{SRS}(i−i₀)−1 symbols before an SRS transmission occasion i−i₀ and K_{SRS}(i) symbols before an SRS transmission occasion i on the active UL BWP b of the carrier f of the serving cell c and the subcarrier spacing μ. Here, i₀ may be such a minimum positive integer that causes K_{SRS}(i−i₀)−1 symbols of the SRS transmission occasion i−i₀ to be earlier than K_{SRS}(i) symbols of the SRS transmission occasion i.

If SRS transmission is aperiodic, K_{SRS}(i) may be the number of symbols in the active UL BWP b of the carrier f of the serving cell c after the last symbol of a corresponding PDCCH triggering the SRS transmission and before the first symbol of the SRS transmission. If SRS transmission is semi-persistent or periodic, K_{SRS}(i) may be the number of K_{SRS,min} symbols equal to a product of the number of symbols N_{symb}^{slot} per slot and a minimum value of a value provided by k2 in PUSCH common configuration information (PUSCH-ConfigCommon) in the active UL BWP b of the carrier f of the serving cell c.

In Rel. 15/16, P0 and α for one closed loop (CL) state index are configured by RRC.

In Rel. 17, when TCI-State is provided in dl-OrJointTCI-StateList or TCI-UL-State, P0 and α for one closed loop (CL) state index follow the following:
When followUnifiedTCIstateSRS (a configuration that the SRS follows a unified TCI state) is provided, they are given by p0AlphaSetforSRS associated with indicated TCI-State or indicated TCI-UL-State.
Otherwise, when followUnifiedTCIstateSRS is not provided, they are given by p0AlphaSetforSRS associated with TCI-State or TCI-UL-State of an SRS resource with lowest SRS-ResourceId in the SRS resource set.

In Rel. 15/16, a PL-RS is given by pathlossReferenceRS associated with the SRS resource set qₛ. When pathlossReferenceRS is not provided, the UE uses an SS used to obtain an MIB/SS of a PBCH block/the same SS as a PBCH block index/SS with a PBCH block index/RS resource obtained from a PBCH block for path loss calculation (uses it as the RS resource index q_{d} for the path loss PL, or uses it as the PL-RS). When neither pathlossReferenceRS nor spatialRelationInfo is provided, and enableDefaultBeamPL-ForSRS is configured, the UE uses a default RS for path loss calculation (uses it as the RS resource index q_{d} for the path loss PL, or uses it as the PL-RS). An index of the default RS provides a periodic RS resource configured with qcl-Type set to ‘type D’ in the following TCI state or QCL assumption:
When a CORESET is provided in the active DL BWP of the serving cell c, a TCI state or QCL assumption of a CORESET with the lowest index in the active DL BWP.
When a CORESET is not provided in the active DL BWP of the serving cell c, an active PDSCH TCI state with the lowest ID in the active DL BWP.

In Rel. 17, when TCI-State is provided in dl-OrJointTCI-StateList (a list of DL or joint TCI states) or TCI-UL-State (UL TCI state), the PL-RS follows the following:
When followUnifiedTCIstateSRS is provided, configured TCI-State, or indicated TCI-State from a set of indicated TCI-UL-State, or indicated TCI-UL-State, which is an applied TCI state.
Otherwise, the same RS as the PL-RS in Rel. 15/16 described above.

### (Maximum Transmission Power (P_{CMAX}))

Maximum transmission power P_{CMAX} is defined for each case of FR1, FR2, and mutual operation (for example, EN-DC). P_{CMAX} is applied in each case of single carrier, CA, and DC, for example. For example, in a case of a single carrier in FR1, P_{CMAX} is defined as in the following expression.

$${P}_{CMAX \_ L , f , c} \leq {P}_{CMAX , f , c} \leq {P}_{CMAX \_ H , f , c} \qquad ( 2 )$$

$$with$$

$${P}_{CMAX \_ L , f , c} = MIN \{ {P}_{EMAX , c} - Δ {T}_{C , c} , ( {P}_{PowerClass} - Δ {P}_{PowerClass} ) - MAX ( MAX ( {MPR}_{c} + Δ {MPR}_{c} , A - {MPR}_{c} ) + Δ {T}_{IB , c} + Δ {T}_{C , c} + Δ {T}_{RxSRS} , P - {MPR}_{c} ) \}$$

$${P}_{CMAX \_ H , f , c} = MIN \{ {P}_{EMAX , c} , {P}_{PowerClass} - Δ {P}_{PowerClass} \}$$

The UE calculates P_{CMAX} using above expression (2), and transmits (reports) it to a base station (gNB) using a PHR MAC CE. This allows the base station to know P_{CMAX} determined by the UE.

Parameters will be described below.
P_{EMAX}: Given by additionalPmax in an RRC information element NR-NS-PmaxList, or a p-Max information element (configured by the base station).

P_{PowerClass}: Maximum power of a UE indicated in a specification, and a parameter not taking allowable errors indicated in a specification into consideration. The parameter is determined by the UE, and is known to the base station.
ΔP_{PowerClass}: Parameter indicating power adjustment of a high-output UE based on a specific condition. The parameter is determined by the UE, and is known to the base station when the UE supports PC3.
ΔT_{IB,c}: Additional tolerance for the serving cell c of NR Carrier Aggregation (CA), a Supplemental UpLink (SUL), and E-UTRA-NR Dual Connectivity (EN-DC). The parameter is defined in a specification.
MPR: Represents maximum power reduction, and is used to limit UL transmission power.
A-MPR: Represents additional maximum power reduction, and is used to limit UL transmission power. Total maximum power reduction is max (MPR, A-MPR).
ΔMPR: Indicates a variation of MPR.
ΔT_{RxSRS}: Parameter applied at the time of SRS transmission when the usage of SRS-ResourceSet is ‘antennaSwitching’.
P-MPR: Represents power management maximum power reduction. The parameter is used to ensure compliance with applied electromagnetic energy absorption requirements and address unwanted emission/self-sensing requirements when simultaneous transmission is performed in a plurality of Radio Access Technologies (RATs) in scenarios outside the scope of 3GPP RAN specifications. The parameter is used to ensure compliance with applied electromagnetic energy absorption requirements when proximity detection is used to address requirements that require lower maximum output power.
   (Port Distribution to which TDM is Applied)

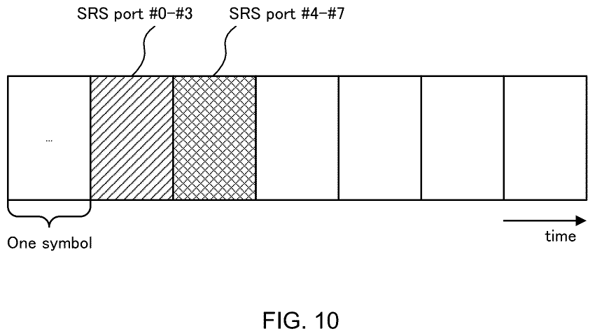

When the usage of the SRS is antenna switching/codebook, supporting of measurement of a UL channel with eight ports (eight layers) using the SRS and mapping of different SRS ports to different OFDM symbols (i.e., TDM) has been under study (FIG. 10). It is also considered that all the eight ports are mapped to one OFDM symbol.

When port distribution to which TDM is applied (TDM mapping) is applied, because the number of cyclic shifts occupied in one OFDM symbol is small, there is an effect of high robustness against delay. This can increase power for each port. Note that a restriction may be applied that the same frequency resource usage/transmission power is used in a plurality of OFDM symbols.

For example, as the SRS resource configuration, it is considered that allocation of four ports to each OFDM symbol and configuration of 8-port SRS transmission using two or more OFDM symbols are performed (for example, FIG. 10).

Transmission power associated with the SRS transmission occasion i corresponding to SRS transmission configured by SRS resources is defined in a specification (above expression (1)). The SRS transmission means SRS transmission in one or a plurality of OFDM symbols. The transmission power is evenly distributed to antenna ports configured for the SRS (for example, configured according to the SRS resource configuration).

### (Analysis)

In future radio communication systems (for example, 3GPP Rel. 18 or later versions), supporting more than four layers (for example, eight layers) in UL transmission from the terminal (the user terminal, the User Equipment (UE)) has been under study. However, various configurations and the like in a case of supporting SRS ports having more than four ports have not been made clear. For example, transmission power control for the SRS has not been made clear. Consequently, transmission of the SRS using more than four SRS ports may not be appropriately performed.

For example, when the antenna ports configured as described above are divided into a plurality of OFDM symbols, the transmission power of the SRS is considered as total transmission power over the plurality of OFDM symbols. In other words, when eight ports are distributed to a plurality of OFDM symbols it is difficult to boost the transmission power in the current specifications.

In view of this, the inventors of the present invention came up with the idea of a method in which transmission of an SRS using more than four SRS ports can be appropriately performed.

Embodiments according to the present disclosure will be described in detail with reference to the drawings as follows. The radio communication methods according to respective embodiments may each be employed individually, or may be employed in combination.

In the present disclosure, “A/B” and “at least one of A and B” may be interchangeably interpreted. In the present disclosure, “A/B/C” may mean “at least one of A, B, and C”.

In the present disclosure, notify, activate, deactivate, indicate, select, configure, update, determine, and the like may be interchangeably interpreted. In the present disclosure, “support,” “control,” “controllable,” “operate,” “operable,” and the like may be interchangeably interpreted.

In the present disclosure, radio resource control (RRC), an RRC parameter, an RRC message, a higher layer parameter, a field, an information element (IE), a configuration, and the like may be interchangeably interpreted. In the present disclosure, a Medium Access Control control element (MAC Control Element (CE)), an update command, an activation/deactivation command, and the like may be interchangeably interpreted.

In the present disclosure, the higher layer signaling may be, for example, any one or combinations of Radio Resource Control (RRC) signaling, Medium Access Control (MAC) signaling, broadcast information, another message (for example, a message from a core network, such as a positioning protocol (for example, NR Positioning Protocol A (NRPPa)/LTE Positioning Protocol (LPP)) message), and the like.

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

In the present disclosure, the physical layer signaling may be, for example, downlink control information (DCI), uplink control information (UCI), or the like.

In the present disclosure, drop, stop, cancel, puncture, rate match, postpone, not transmit, and the like may be interchangeably interpreted.

As the SRS in the present disclosure, at least one of the P-SRS, the SP-SRS, and the AP-SRS may be used. In the present disclosure, a P SRS and a P-SRS may be interchangeably interpreted. In the present disclosure, an SP SRS and an SP-SRS may be interchangeably interpreted. In the present disclosure, an AP SRS and an AP-SRS may be interchangeably interpreted. A resource set group and an SRS resource set group may be interchangeably interpreted.

In the present disclosure, application of xTyR, transmission (reporting) of “txry” in UE capability information (for example, supportedSRS-TxPortSwitch), and configuration of xTyR in higher layer signaling/physical layer signaling may be interchangeably interpreted. In the present disclosure, UL transmission with the number of layers being greater than 4 may be applied. Processing of the present disclosure may be applied to the UE for which the number of layers being greater than 4 is supported.

In the present disclosure, a port, an SRS port, a transmission port, an SRS transmission port, and an antenna port may be interchangeably interpreted. In the present disclosure, a reception port, an antenna port, and a UE antenna port may be interchangeably interpreted.

In the present disclosure, ports #0 to #7 may be interpreted as ports #1000 to #1007. In other words, 1000 may be added to each port number of ports #0 to #7.

### Radio Communication Method

### Embodiment A0

In a case of receiving a configuration (for example, SRS resource/SRS resource set configuration) indicating that different SRS ports are mapped to different Orthogonal Frequency Division Multiplexing (OFDM) symbols (different SRS ports are sounded in different OFDM symbols) (for example, FIG. 10), the transmission power (for example, P_{SRS,b,f,c}) of the SRS may be evenly divided for each one or plurality of specific units corresponding to the SRS resources. This maximizes the transmission power of the SRS.

### {Option 1}

One or a plurality of (which may be a plurality of) specific units may be at least one of the following options 1-1 to 1-3.

### <<Option 1-1>>

Port (SRS port). For example, when P_{SRS,b,f,c} is divided for the SRS ports, power for each SRS port is P_{SRS,b,f,c}/N1 (N is the number of SRS ports). The SRS ports (the number of SRS ports) may be configured for/indicated to the UE by higher layer signaling/physical layer signaling, or may be determined by the UE.

### <<Option 1-2>>

OFDM symbol. For example, when P_{SRS,b,f,c} is divided for the OFDM symbols configured for the SRS, power for each symbol is P_{SRS,b,f,c}/N2 (N2 is the number of configured OFDM symbols). When repetition transmissions are configured, the OFDM symbols are OFDM symbols used in one repetition.

### <<Option 1-3>>

Subset of SRS ports (OFDM symbols used for the subset). For example, P_{SRS,b,f,c} is divided for subsets of SRS ports configured for the SRS. Power for each subset is P_{SRS,b,f,c}/N3 (N3 is the subsets of configured ports).

Options 1-1 to 1-3 may be performed in combination as appropriate. For example, when options 1-1 and 1-2 are combined, power may be evenly distributed to each SRS port configured for each symbol. For example, when options 1-2 and 1-3 are combined, power may be evenly distributed to each subset of SRS ports configured for each symbol.

### {Option 2}

A restriction/condition for applying the present embodiment may be at least one of the following options 2-1 to 2-2. Satisfying the restriction/condition may correspond to an implicit indication of application of the present embodiment.

### <<Option 2-1>>

Usage of the SRS. For example, when at least one of antenna switching, the codebook, the non-codebook, and beam management is configured as the usage of the SRS, the present embodiment may be applied.

### <<Option 2-2>>

Behavior of the SRS in the time domain. For example, the present embodiment may be applied to aperiodic only, semi-persistent only, periodic only, a subset of {aperiodic, semi-persistent, periodic} only, or all of {aperiodic, semi-persistent, periodic}.

### EXAMPLES OF DESCRIPTION IN SPECIFICATION

The present embodiment may be described in a specification as in the following examples 1 to 3. Note that being described in a specification corresponds to being performed by the terminal. Note that P-indicates a variable with an overline placed over P, and may also be referred to as P-bar.

### Example 1

In a case of the SRS, the UE evenly divides a linear value P⁻_{SRS,b,f,c}(i, qₛ, l) of the transmission power P_{SRS,b,f,c}(i, qₛ, l) among the antenna ports configured in the subset of SRS ports in the active UL BWP b of the carrier f of the serving cell c.

### Example 2

In a case of the SRS not configured with port distribution to which TDM is applied, the UE evenly divides the linear value P⁻_{SRS,b,f,c}(i, qₛ, l) of the transmission power P_{SRS,b,f,c}(i, qₛ, l) among the antenna ports of the SRS in the active UL BWP b of the carrier f of the serving cell c.

In a case of the SRS configured with port distribution to which TDM is applied, the UE evenly divides the linear value P⁻_{SRS,b,f,c}(i, qₛ, l) of the transmission power P_{SRS,b,f,c}(i, qₛ, l) among the antenna ports configured in the subset of SRS ports in the active UL BWP b of the carrier f of the serving cell c.

### Example 3

In a case of the SRS not configured with port distribution to which TDM is applied, the UE evenly divides the linear value P⁻_{SRS,b,f,c}(i, qₛ, l) of the transmission power P_{SRS,b,f,c}(i, qₛ, l) among the antenna ports of the SRS in the active UL BWP b of the carrier f of the serving cell c.

In a case of the SRS configured with port distribution to which TDM is applied, and when the UE indicates a specific UE capability report, the UE evenly divides the linear value P⁻_{SRS,b,f,c}(i, qₛ, l) of the transmission power P_{SRS,b,f,c}(i, qₛ, l) among the antenna ports configured in the subset of SRS ports in the active UL BWP b of the carrier f of the serving cell c.

### {Variations}

When different SRS ports are measured in different OFDM symbols according to the SRS resource configuration, the transmission power (for example, P_{SRS,b,f,c}) Of the SRS is considered for each OFDM symbol in the SRS transmission occasion.

For example, when the UE transmits the SRS in the active UL BWP b of the carrier c of the serving cell c based on the SRS resource set configuration by using the SRS power control adjustment state of index l, the UE determines the SRS transmission power P_{SRS,b,f,c}(i, qₛ, l) for each OFDM symbol in the SRS transmission occasion i.

### <UE Power Amplifier (PA) Architecture>

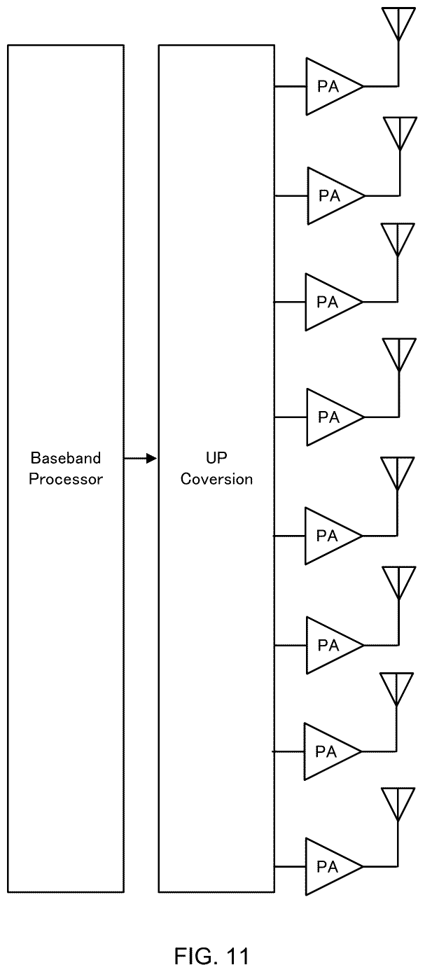

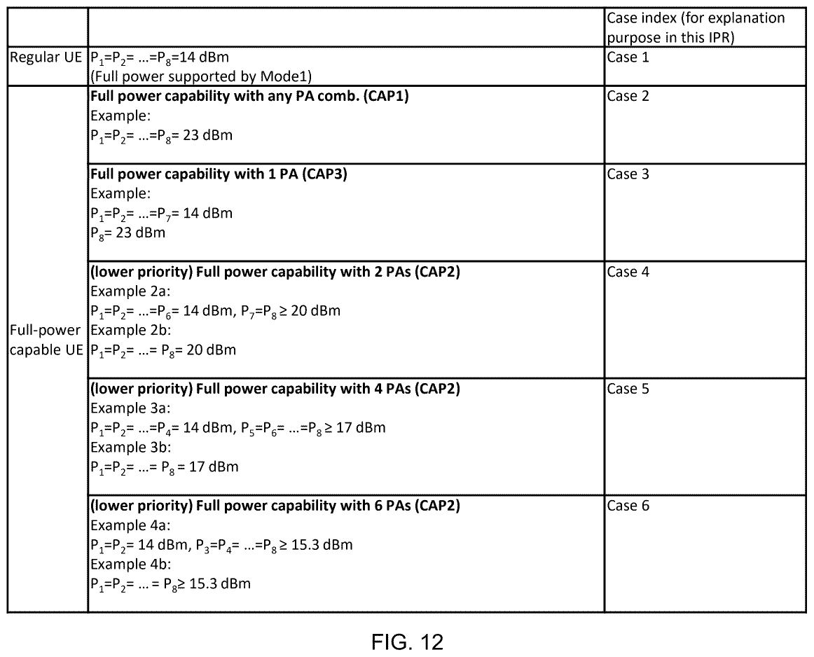

When a signal is transmitted, it is transmitted from a baseband processor to PAs via up-conversion to be amplified and then transmitted to antennas (FIG. 11). As shown in FIG. 12, a plurality of cases are assumed for transmission power. For example, in case 1, power of the amplified signal is 14 [dBm] in each port.

### <Actual Maximum Transmission Power>

In a case of FIG. 12, when ports #0 to #3 are mapped to a certain symbol and ports #4 to #7 are mapped to another symbol, it is considered that the transmission power and the maximum transmission power of each port are as follows, for example.
In case 1 of {14, 14, 14, 14, 14, 14} [dBm], the maximum transmission power is 20 dBm/symbol.
In case 2 of {23, 23, 23, 23, 23, 23} [dBm], there is no restriction that the maximum transmission power is less than 23 dBm.
In case 3 of {14, 14, 14, 14, 14, 23} [dBm], the maximum transmission power is 20 dBm in a certain symbol and 23 dBm in another symbol.
In case 4 of {14, 14, 14, 14, 20, 20} [dBm], the maximum transmission power is 20 dBm in a certain symbol and 23 dBm in another symbol.
In case 5 of {14, 14, 14, 17, 17, 17} [dBm], the maximum transmission power is 20 dBm in a certain symbol and 23 dBm in another symbol.
In case 6 of {14, 14, 15.3, 15.3, 15.3, 15.3, 15.3}, the maximum transmission power is 20 dBm or more in a certain symbol and 21.3 dBm or more in another symbol.

In different OFDM symbols used for SRS resources, different transmission powers are available depending on the UE PA architecture. This may affect a method of measuring CSI via a subset of ports.

### <Analysis>

In a plurality of OFDM symbols used for SRS resources, one P_{CMAX} is considered as the upper limit of the transmission power. On the other hand, depending on the UE PA architecture, actual maximum transmission power is different for each OFDM symbol (a different port is transmitted).

For example, it is also considered to study conservative P_{CMAX}. For example, in case 3 of the UE PA architecture of FIG. 12, it is also considered that the symbol in SRS ports #0 to #3 cannot achieve 23 dBm and P_{CMAX} is thus set to 20 dBm.

In other words, it is preferable that the UE adjust the SRS transmission power, based on a transmitted SRS port/UE PA architecture type. The adjustment method will be described below in detail in Embodiment A1 to Embodiment A3.

### Embodiment A1

In order to reflect actual maximum transmission power based on a transmitted SRS port/UE PA architecture type, the UE may perform power adjustment on the maximum transmission power (for example, P_{CMAX}) for SRS transmission. For example, although a limit of P_{CMAX} as shown in above expression (2) is defined in Rel. 17, a different expression may be used in the present embodiment.

### {Option 1}

A power adjustment coefficient is at least one of the following options 1-1 and 1-2.
Option 1-1: ΔT_{RxSRS} of expression (2) is applied as it is.
Option 1-2: A new parameter is added to expression (2). For example, the following expression with an addition of ΔT_{RxSRS_NEW} may be applied.

$${P}_{CMAX \_ L , f , c} \leq {P}_{CMAX , f , c} \leq {P}_{CMAX \_ H , f , c} \qquad ( 3 )$$

$$with$$

$${P}_{CMAX \_ L , f , c} = MIN \{ {P}_{EMAX , c} - Δ {T}_{C , c} , ( {P}_{PowerClass} - Δ {P}_{PowerClass} ) - MAX ( MAX ( {MPR}_{c} + Δ {MPR}_{c} , A - {MPR}_{c} ) + Δ {T}_{IB , c} + Δ {T}_{C , c} + Δ {T}_{RxSRS} + Δ {T}_{RxSRS \_ NEW} , P - {MPR}_{c} ) \}$$

$${P}_{CMAX \_ H , f , c} = MIN \{ {P}_{EMAX , c} , {P}_{PowerClass} - Δ {P}_{PowerClass} \}$$

### {Option 2}

The location to which the coefficient is applied may be at least one of the following options 2-1 to 2-3. For example, a specific coefficient may be applied (for example, added/subtracted/multiplied) to at least one of the expressions of options 2-1 to 2-3. The expressions of options 2-1 to 2-3 may each be above expression (2) or (3).
Option 2-1: Inequality for determining P_{CMAX,f,c}.
Option 2-2: Expression for determining a lower-limit band (P_{CMAX,L,f,c}).
Option 2-3: Expression for determining an upper-limit band (P_{CMAX,H,f,c}).

### {Option 3}

A condition for applying the present embodiment is at least one of the following options 3-1 and 3-2.
Option 3-1: The present embodiment is applied to an SRS having a port index larger (or smaller) than a certain threshold. For example, when there are four ports for each subset/OFDM symbol in an 8-port SRS, the example of the present embodiment may be applied to SRS ports #4 to #7. For example, when there are two ports for each subset in an 8-port SRS, the application need not be carried out for only ports #6 and #7 of the SRS.
Option 3-2: The application is carried out for only an SRS having a port index in a specific subset.

According to the present embodiment, the transmission power of the SRS is maximized based on the actual PA architecture.

### Embodiment A2

In order to reflect actual maximum transmission power based on a transmitted SRS port/UE PA architecture type, the UE may perform power adjustment on a value associated with TPC (TPC command) for SRS transmission. For example, although h_{b,f,c}(i) corresponding to TPC as shown in above expression (2) is used in Rel. 17, a specific coefficient may be applied (for example, added/subtracted/multiplied) to h_{b,f,c}(i, l) in the present embodiment.

### {Option 1}

A power adjustment coefficient is at least one of the following options 1-1 and 1-2.
Option 1-1: ΔT_{RxSRS} of expression (2) is applied as it is.
Option 1-2: A new parameter is added to expression (2). For example, above expression (3) with an addition of ΔT_{RxSRS_NEW} may be applied.

### {Option 2}

The location to which the coefficient is applied may be at least one of the following options 2-1 to 2-2. For example, a specific coefficient may be applied (for example, added/subtracted/multiplied) to at least one of the expressions of options 2-1 to 2-2.
Option 2-1: Lower expression (for example, after P_{0_SRS,b,f,c}) of expression (2) or (3).
Option 2-2: Upper expression (for example, after P_{CMAX,f,c}) Of expression (2) or (3).

### {Option 3}

A condition for applying the present embodiment is at least one of the following options 3-1 and 3-2.
Option 3-1: The present embodiment is applied to an SRS having a port index larger (or smaller) than a certain threshold. For example, when there are four ports for each subset/OFDM symbol in an 8-port SRS, the example of the present embodiment may be applied to SRS ports #4 to #7. For example, when there are two ports for each subset in an 8-port SRS, the application need not be carried out for only ports #6 and #7 of the SRS.
Option 3-2: The application is carried out for only an SRS having a port index in a specific subset.

According to the present embodiment, the transmission power of the SRS is maximized based on the actual PA architecture.

### Embodiment A3

In order to reflect actual maximum transmission power based on a transmitted SRS port/UE PA architecture type, the UE may perform power adjustment on calculated SRS transmission power (for example, P_{SRS,b,f,c}(i, qₛ, l)).

### {Option 1}

A power adjustment coefficient is at least one of the following options 1-1 and 1-2.
Option 1-1: ΔT_{RxSRS} of expression (2) is applied as it is.
Option 1-2: A new parameter is added to expression (2). For example, above expression (3) with an addition of ΔT_{RxSRS_NEW} may be applied.

### {Option 2}

The location to which the coefficient is applied may be the expression of the following option 2-1. For example, a specific coefficient may be applied (for example, added/subtracted/multiplied) to the expression of option 2-1.
Option 2-1: After P_{SRS,b,f,c}(i, qₛ, l) of expression (2) or (3).

### {Option 3}

A condition for applying the present embodiment is at least one of the following options 3-1 and 3-2.
Option 3-1: The present embodiment is applied to an SRS having a port index larger (or smaller) than a certain threshold. For example, when there are four ports for each subset/OFDM symbol in an 8-port SRS, the example of the present embodiment may be applied to SRS ports #4 to #7. For example, when there are two ports for each subset in an 8-port SRS, the application need not be carried out for only ports #6 and #7 of the SRS.
Option 3-2: The application is carried out for only an SRS having a port index in a specific subset.

According to the present embodiment, the transmission power of the SRS is maximized based on the actual PA architecture.

### <Variations>

The examples of Embodiment A1 to Embodiment A3 may be applied in common to a set of SRS transmission. The “set of SRS transmission” may be replaced with at least one of the following.
(1) Subset of all configured SRS ports.
(2) All repetitions of SRS transmission.
(3) All SRS symbols. In this case, for example, the transmission power of the OFDM symbols is the same, and thus implementation of the terminal is simplified.
(4) Part of a subset (which may be a plurality of subsets) of configured SRS ports.
(5) Part of SRS ports.

When (1) to (3) are applied, the transmission power of the SRS is the same among specific SRS transmissions configured by SRS resources, and thus implementation of the terminal is simplified. The UE may select a minimum/maximum power value calculated for each SRS subset/SRS repetition/SRS symbol (an SRS corresponding to the power value), and apply each embodiment.

P_{CMAX} may be defined for each port (or for each port subset).

A method of determining/identifying the “SRS having a port index in a specific subset” of option 3-2 of Embodiment A1 to Embodiment A3 may be at least one of the following (1) to (3).
(1) The UE transmits the SRS ports in each subset and the number of subsets as UE capability information. The UE may be configured/indicated with a specific subset by RRC/MAC CE/DCI.
(2) When the SRS ports are divided into a plurality of subsets, the UE may be configured/indicated with respective identifiers of the subsets by RRC/MAC CE/DCI. The UE may be configured/indicated with the divided subsets by RRC/MAC CE/DCI.
(3) The UE may be configured/indicated with an association between the SRS ports and the OFDM symbols used for transmission thereof by RRC/MAC CE/DCI. The SRS ports included in the same OFDM symbol may be included in the same subset.

### Embodiment A4

In Embodiment A1 to Embodiment A3, the UE may transmit/report a coefficient used for adjustment by using a report/information/signal/channel or the like of at least one of the following options (it may be included in the information/signal/channel or the like).
Option 4-1-1: UE capability information.
Option 4-1-2: Report in a MAC CE (for example, a Power Headroom Report (PHR)/buffer status report (BSR)) on a UL PUSCH.
Option 4-1-3: UCI on a PUCCH.
Option 4-1-4: UCI on a PUSCH.

The UE may transmit a specific unit/location for applying one or a plurality of coefficients together with the coefficient, or it may be defined in a specification in advance.

### {Variations}

Information related to the UE PA architecture may be transmitted/reported using methods of options 4-1-1 to 4-1-2. This enhances recognition of the gNB with respect to transmission power of the UE. In this case, the “information related to the UE PA architecture” may be at least one of the following.
Option 4-2-1: Maximum output power for each port.
Option 4-2-2: Identification information of PA architecture (for example, the case indices of FIG. 12).

According to the present embodiment, quality of UL/DL channel measurement based on the SRS is enhanced.

### Embodiment A5

When the UE receives both of a configuration of TDM port distribution (different SRS ports being mapped to OFDM symbols) and a configuration of SRS repetitions, the UE may drop only a part of the SRS (SRS symbols) in the SRS repetitions, according to a collision with another UL transmission. Note that, as shown in the example of FIG. 10 as well, TDM port distribution may indicate that different SRS ports are mapped to different OFDM symbols (i.e., TDM).

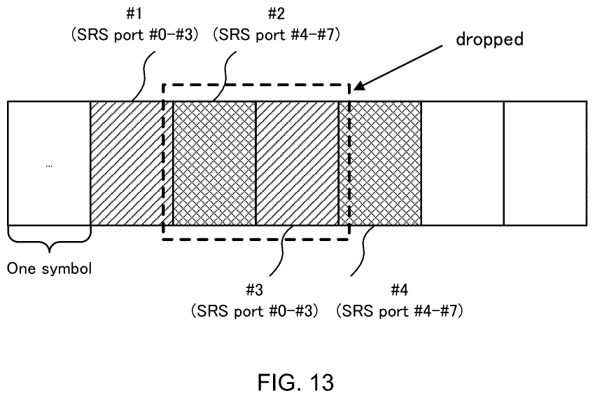

The UE may drop only an SRS transmission from the SRS ports in symbols overlapping another UL transmission, and may not drop an SRS transmission from the SRS ports in other symbols. For example, in the example of FIG. 13, the UE drops only the SRSs of #2 and #3. This can reduce the SRSs to be dropped as compared to a case in which all the SRSs (for example, all the SRSs in repetition transmissions corresponding to a specific SRS) are dropped. Channel measurement for all the ports can be performed regardless of an overlap with another UL transmission.

For example, when the UE is simultaneously configured with the SRS of TDM port distribution and SRS repetitions, the UE may apply the following option 5-1 or 5-2 as a rule for handling a collision between the SRS and another UL transmission.
Option 5-1: When an SRS symbol including a repetition collides with another UL transmission, the UE drops all the SRS transmissions in repetition transmissions.
Option 5-2: When any of the SRS symbols including a repetition collides with another UL transmission, the UE drops only all the SRS transmissions that actually collide with another UL transmission.

According to the present embodiment, the SRS transmission occasions (corresponding to occasions of measuring CSI) are maximized. For example, when the present embodiment, Embodiment A1 to Embodiment A3, and Embodiment A4 are combined, a NW (base station) can measure eight ports assuming appropriate transmission power, and can thereby obtain accurate UL measurement results.

### {Supplements}

When UL transmissions overlap, the UE may drop a UL transmission having low priority, according to a certain order of priority. For example, the following UL transmissions may be assigned high priority. The priority may be defined in a specification, or may be configured for/indicated to the UE by higher layer signaling/physical layer signaling.
PRACH transmission on a PCell.
PUCCH or PUSCH transmission having a large priority index.
PUCCH or PUSCH transmission having the same priority index.
At least one of PUCCH transmission having HARQ-ACK information of a priority index, and PUSCH transmission having an SR, a link recovery request (LRR), and HARQ-ACK information.
PUCCH transmission having CSI or PUSCH transmission having CSI.
PUSCH transmission not having HARQ-ACK information of a priority index or CSI, PUSCH transmission in a type 2 random access procedure, or PUSCH transmission on a PCell.
SRS transmission or PRACH transmission having priority higher than a semi-persistent/periodic SRS in a serving cell other than a PCell.

In a case of the same priority and an operation with carrier aggregation, the UE may prioritize transmission in a primary cell of an MCG or an SCG over transmission in a secondary cell and perform the transmission. In a case of the same priority and an operation using two UL carriers, the UE may prioritize transmission on a carrier in which the UE is configured to transmit a PUCCH. When a PUCCH is not configured in either of the two UL carriers, the UE may prioritize transmission in a non-supplemental UL carrier.

### <8-Port TDM>

When eight ports are distributed with the TDM scheme, cyclic mapping of port subsets and use of the same set of subcarriers in one subset have been under study. In resource mapping based on 8-port SRS resources in the SRS resource set having the usage of ‘codebook’ or ‘antennaSwitching’ and TDM using TDM factors s, when s subsets of ports are mapped to m≥2 OFDM symbols in one slot according to a pattern of {1, 2, . . . , s}, . . . , {1, 2, . . . , s} (in total, m/s groups of {1, 2, . . . , s}), the SRS resources in each of the m/s groups of {1, 2, . . . , s} use the same set of subcarriers. When consecutive groups of {1, 2, . . . , s} are configured as repetitions, the SRS transmissions of the consecutive groups use the same set of subcarriers. The distribution may be applied to SRS resources using frequency hopping (FH)/resource block-level partial frequency sounding (RPFS), or may be applied to SRS resources not using FH/RPFS.

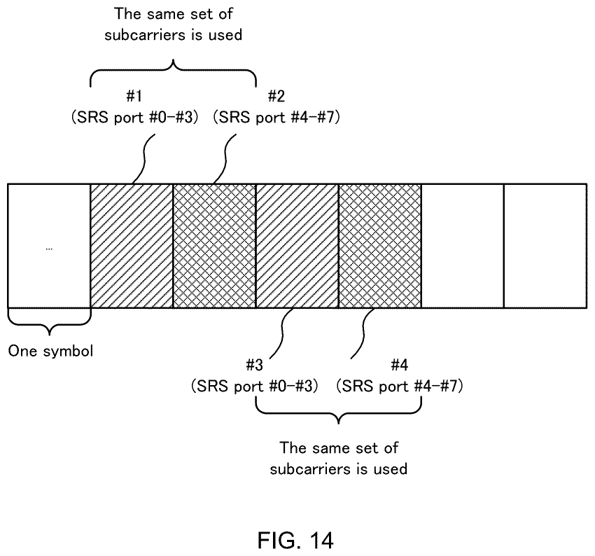

In the example of FIG. 14, 8-port SRSs are distributed to s=2 consecutive symbols with four ports each to be subjected to TDM. When the group is repeated m/s=2 times, two groups are mapped to m=4 symbols in one slot.

In the present disclosure, one subset (port subset) may correspond to one symbol (OFDM symbol, SRS symbol) and 8/s ports. In the present disclosure, one group may correspond to s symbols, s subsets, and eight ports. In the present disclosure, all SRS symbols (Ns symbols) may correspond to m symbols and m/s groups.

### <SRS Repetition and Frequency Hopping>

SRS repetition and intra-slot frequency hopping are determined based on the following several parameters.
Ns (number of symbols) {n1, n2, n4, n8, n10, n12, n14}: Total number of SRS symbols in one slot.
R (repetition factor) {n1, n2, n4, n5, n6, n7, n8, n10, n12, n14}: Number of repeated SRS transmissions.

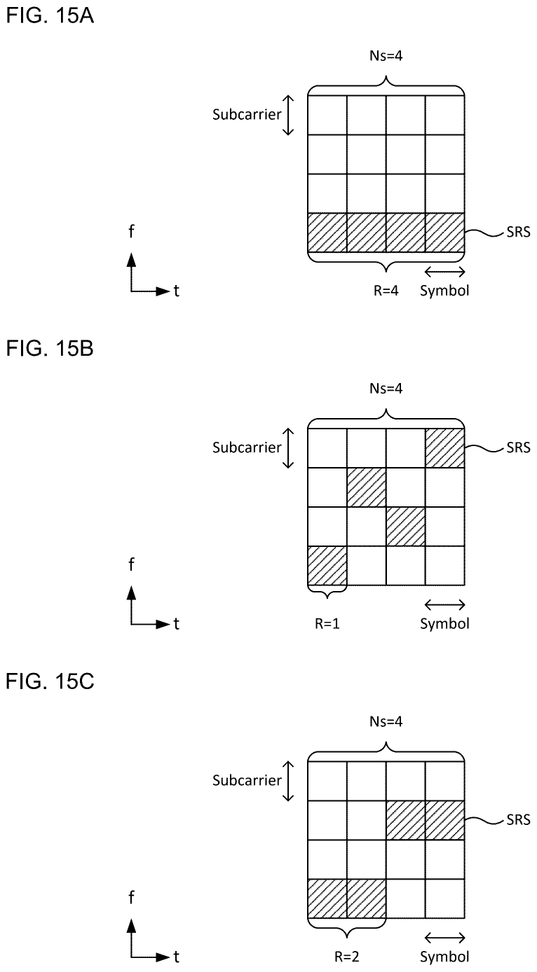

Ns and R may follow at least one of the following several examples.
Example 1: When R=Ns, all SRS symbols (Ns symbols) use the same set of subcarriers. In the example of FIG. 15A, Ns=4 and R=4.
Example 2: When R=1, different SRS symbols use different sets of subcarriers. In the example of FIG. 15B, Ns=4 and R=1.
Example 3: When R>=2 and Ns>=4, R adjacent SRS symbols use the same set of subcarriers. In the example of FIG. 15C, Ns=4 and R=2.

### <Analysis>

Sufficient study has not been carried out on a relationship between the following plurality of configurations (parameters).
Number of repetitions R.
Number of SRS symbols Ns.
Number of port subsets s (new parameter for the 8-port SRS to be subjected to TDM).

Sufficient study has not been carried out on a relationship between the SRS ports to be subjected to TDM and comb offset hopping. Whether comb offset hopping is performed for each symbol or is performed for each cycle of the port subset has not been made clear.

### <UE Operation>

The UE may receive information (for example, a configuration/indication) related to sounding reference signal (SRS) transmission using a plurality of ports being more than four ports. The UE may determine at least one of the number of repetitions (for example, R) of the SRS transmission, the number of symbols (for example, the number of port subsets s) to which the plurality of ports are mapped, and the number of ports out of the plurality of ports (for example, the number of ports in one port subset, the number of ports/s) to be mapped to one symbol, based on the information.

The UE may receive information (for example, a configuration/indication) related to sounding reference signal (SRS) transmission using a plurality of ports being more than four ports. The UE may control hopping of a comb offset in the SRS transmission, based on the information.

When TDM port mapping for the SRS using more than four ports is configured, the UE may repeatedly transmit the SRS of one symbol corresponding to one port subset R times, may repeatedly transmit the SRS of s symbols corresponding to s port subsets R times, or may repeatedly transmit the SRS of m symbols R times.

### Embodiment 1

When TDM port mapping for the SRS using more than four ports is configured, a restriction (limitation) on the RRC parameter R (the number of repetitions for the SRS) may be applied. According to the present embodiment, a mismatch between the SRS repetitions and the port subsets does not occur, and all the subsets can be repeated the same number of times.
Option 1: The restriction may be at least one of the following several options.
   Option 1-1: R may take existing candidate values. In other words, R may be 1, 2, 4, 5, 6, 7, 8, 10, 12, or 14.
   Option 1-2: R may take values other than 1 among existing candidate values. In other words, R may be 2, 4, 5, 6, 7, 8, 10, 12, or 14.
   Option 1-3: R may take only even number values among existing candidate values. In other words, R may be 2, 4, 6, 8, 10, 12, or 14.
   Option 1-4: R is Ns (number of SRS symbols) or less.
   Option 1-5: R may take multiples of the number of port subsets s. For example, when s=2, R may be the same set as that of option 1-3. For example, when s=4, R may be 4, 8, or 12.
Option 2: The restriction may be applied with at least one of the following several options.
   Option 2-1: Explicit RRC parameter.
   Option 2-2: RRC parameter for configuring an SRS using more than four ports.
   Option 2-3: DL MAC CE indication.
   Option 2-4: DCI indication. The DCI may be DCI that triggers A-SRS transmission.

### Embodiment 2

When TDM port mapping for the SRS using more than four ports is configured, at least one of the number of port subsets s and the number of ports in one port subset (i.e., the number of ports/s) may be determined based at least on the number of repetitions R. According to the present embodiment, overhead of the configuration required for the 8-port SRS to be subjected to TDM can be reduced (minimized).
Option 1: At least one of the number of port subsets s and the number of ports in one port subset (i.e., the number of ports/s) may follow at least one of the following several options.
   Option 1-1: The number of port subsets s is the same as R. In this case, the restriction on R may be applied. R may be a maximum number of port subsets or less. The restriction of at least one of options 1-1 to 1-5 in Embodiment 1 may be further applied on R.
Option 2: The number of port subsets s is R/X. Here, X may be configured by an RRC parameter. X may be selected from 2, 4, and 8. In this case, the value of R may be required to be an integer that can be divided by the selected value of X without a remainder (may be a multiple of the selected value of X).

### Embodiment 3

When TDM port mapping for the SRS using more than four ports is configured, at least one of the number of port subsets s and the number of ports in one port subset (i.e., the number of ports/s) may be determined based on an explicit RRC parameter. The RRC parameter related to SRS transmission may indicate at least one of the number of port subsets s and the number of ports in one port subset (i.e., the number of ports/s). According to the present embodiment, flexible configuration of at least one of the number of port subsets s and the number of ports in one port subset (i.e., the number of ports/s) can be performed.

### Embodiment 4

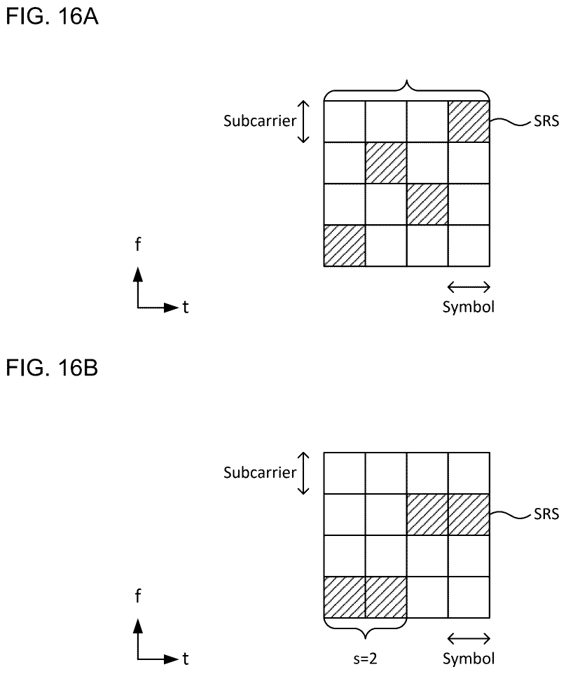

When TDM port mapping for the SRS using more than four ports is configured, comb offset hopping based on specific granularity may be performed. According to the present embodiment, the UE/base station can appropriately perform comb offset hopping.
Option 1: The specific granularity may be at least one of the following several options.
   Option 1-1: Comb offset hopping is performed for each OFDM symbol (for example, FIG. 16A).
   Option 1-2: Comb offset hopping is performed for each set of SRS symbols. The set of SRS symbols is a set of SRS symbols required for transmission of all the SRS ports. The number of SRS symbols in the set may be equal to the number of port subsets s (for example, FIG. 16B).
   Option 1-3: Comb offset hopping is performed every R symbols. R may be a repetition factor (for example, one of FIG. 15A to FIG. 15C). Option 1-3 may be applied to the SRS using four or less ports.
Option 2: Configurability of options 1-1 to 1-3 described above may follow at least one of the following several options.
   Option 2-1: Only one option of options 1-1 to 1-3 is supported.
   Option 2-2: All the options of options 1-1 to 1-3 are supported, and one option of the plurality of options is configured by RRC.
   Option 2-3: All the options of options 1-1 to 1-3 are supported, a subset of the plurality of options is configured by RRC, and one option of the subset is indicated by MAC CE/DCI.
   Option 2-4: Only a subset of options 1-1 to 1-3 is supported, and one option of the subset is configured by RRC.

### Embodiment 5

When TDM port mapping for the SRS using more than four ports is configured, comb offset hopping need not be configured. In other words, a specification may define that the UE does not expect that TDM port mapping and comb offset hopping are simultaneously configured. According to the present embodiment, the UE can be appropriately configured with TDM port mapping or comb offset hopping.

### <Supplements>

### {Notification of Information to UE}

Notification of any information to a UE (from a network (NW) (for example, a base station (BS))) (in other words, reception of any information from the BS in the UE) in the above-described embodiments may be performed by using physical layer signaling (for example, DCI), higher layer signaling (for example, RRC signaling, MAC CE), a specific signal/channel (for example, a PDCCH, a PDSCH, a reference signal), or a combination of these.

When the notification is performed by a MAC CE, the MAC CE may be identified by a new logical channel ID (LCID) not defined in an existing standard being included in a MAC subheader.

When the notification is performed by DCI, the notification may be performed by a specific field of the DCI, a radio network temporary identifier (RNTI) used for scrambling of cyclic redundancy check (CRC) bits given to the DCI, a format of the DCI, or the like.

Notification of any information to a UE in the above-described embodiments may be performed periodically, semi-persistently, or aperiodically.

{Notification of Information from UE}

Notification of any information from a UE (to an NW) (in other words, transmission/reporting of any information to the BS from the UE) in the above-described embodiments may be performed by using physical layer signaling (for example, UCI), higher layer signaling (for example, RRC signaling, MAC CE), a specific signal/channel (for example, a PUCCH, a PUSCH, a PRACH, a reference signal), or a combination of these.

When the notification is performed by a MAC CE, the MAC CE may be identified by a new LCID not defined in existing standards being included in a MAC subheader.

When the notification is performed by UCI, the notification may be transmitted by using a PUCCH or a PUSCH.

Notification of any information from a UE in the above-described embodiments may be performed periodically, semi-persistently, or aperiodically.

### Regarding Application of Each Embodiment

At least one of the above-described embodiments may be applied to a case satisfying a specific condition. The specific condition may be defined in a standard, or a UE/BS may be notified of the specific condition by using higher layer signaling/physical layer signaling.

At least one of the above-described embodiments may be applied to only one of the following several SRSs.
SRS using more than four ports.
SRS using more than four ports and using ports subjected to TDM.
SRS with a specific time domain operation (for example, AP/SP/P).
SRS with a specific usage (for example, CB/NCB/antenna switching/beam management).

At least one of the above-described embodiments may be applied only to a UE that has reported a specific UE capability or that supports the specific UE capability. Note that “to support” and “whether to support” may be interchangeably interpreted.

The specific UE capability may indicate at least one of the following:
supporting of specific processing/operation/control/information regarding at least one of the embodiments described above.
supporting of a restriction on R.
supporting of determination of the number of port subsets (as in Embodiment 2).

The specific UE capability may be capability applied over all the frequencies (commonly irrespective of frequency), capability per frequency (for example, one or a combination of cell, band, band combination, BWP, component carrier, and the like), capability per frequency range (for example, Frequency Range 1 (FR1), FR2, FR3, FR4, FR5, FR2-1, FR2-2), capability per subcarrier spacing (SCS), or capability per Feature Set (FS) or Feature Set Per Component-carrier (FSPC).

The specific UE capability may be capability applied over all the duplex schemes (commonly irrespective of duplex scheme) or capability per duplex scheme (for example, time division duplex (TDD) or frequency division duplex (FDD)).

At least one of the above-described embodiments may be applied when the UE is configured/activated/triggered with specific information related to the above-described embodiment (or performance of the operation of the above-described embodiment) by higher layer signaling/physical layer signaling. For example, the specific information may be any RRC parameter for a specific release (for example, Rel. 18/19) or the like.

In Rel. YY (for example, YY is 18 or greater), an RRC parameter for enabling operation XXX may be represented by XXX_rYY (XXX-rYY).

When the UE does not support at least one of the specific UE capabilities above or is not configured with the specific information, operation of Rel. 15/16/17 may be applied, for example.

### Supplementary Note

Regarding one embodiment of the present disclosure, the following supplementary notes of the invention will be given.

### Supplementary Note 1

A terminal including:
a receiving section that receives information related to sounding reference signal (SRS) transmission using a plurality of ports being more than four ports; and
a control section that determines, based on the information, at least one of a number of repetitions of the SRS transmission, a number of symbols to which the plurality of ports are mapped, and a number of ports out of the plurality of ports to be mapped to one symbol.

### Supplementary Note 2

The terminal according to supplementary note 1, wherein the number of repetitions is limited as compared to a case in which four or less ports are used.

### Supplementary Note 3

The terminal according to supplementary note 1 or 2, wherein the control section determines at least one of the number of symbols and the number of ports, based on the number of repetitions.

### Supplementary Note 4

The terminal according to any one of supplementary notes 1 to 3, wherein the information indicates at least one of the number of symbols and the number of ports.

### Supplementary Note

Regarding one embodiment of the present disclosure, the following supplementary notes of the invention will be given.

### Supplementary Note 1

A terminal including:
a receiving section that receives information related to sounding reference signal (SRS) transmission using a plurality of ports being more than four ports; and
a control section that controls, based on the information, hopping of a comb offset in the SRS transmission.

### Supplementary Note 2

The terminal according to supplementary note 1, wherein the control section performs the hopping for each granularity of at least one of a symbol, a plurality of symbols to which the plurality of ports are mapped, and symbols of a number of repetitions of the SRS transmission.

### Supplementary Note 3

The terminal according to supplementary note 1 or 2, wherein the information indicates granularity of at least one of a symbol, a plurality of symbols to which the plurality of ports are mapped, and the symbols of the number of repetitions of the SRS transmission.

### Supplementary Note 4

The terminal according to any one of supplementary notes 1 to 3, wherein use of the plurality of ports being more than four ports and the hopping are not simultaneously configured.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

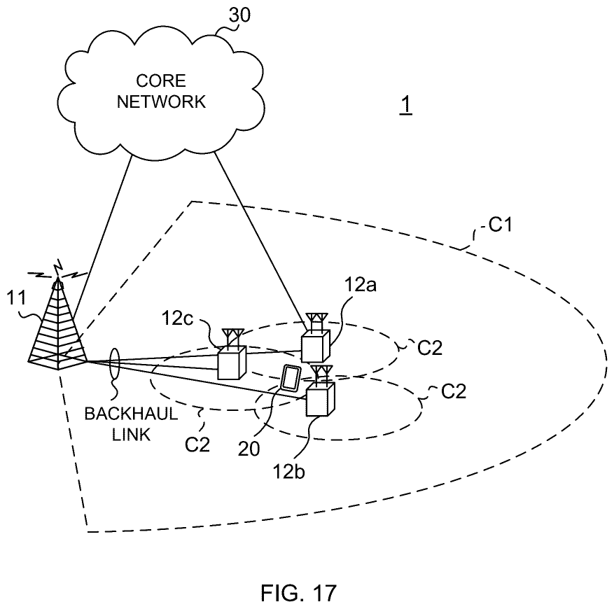

FIG. 17 is a diagram to show an example of a schematic structure of the radio communication system according to one embodiment. A radio communication system 1 (which may be simply referred to as a system 1) may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHZ), and FR2 may be a frequency band which is higher than 24 GHZ (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The core network 30 may include network functions (NFs), such as a User Plane Function (UPF), an Access and Mobility management Function (AMF), a Session Management Function (SMF), Unified Data Management (UDM), an Application Function (AF), a Data Network (DN), a Location Management Function (LMF), and Operation, Administration and Maintenance (Management) (OAM), for example. Note that a plurality of functions may be provided by one network node. Communication with an external network (for example, the Internet) may be performed via the DN.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

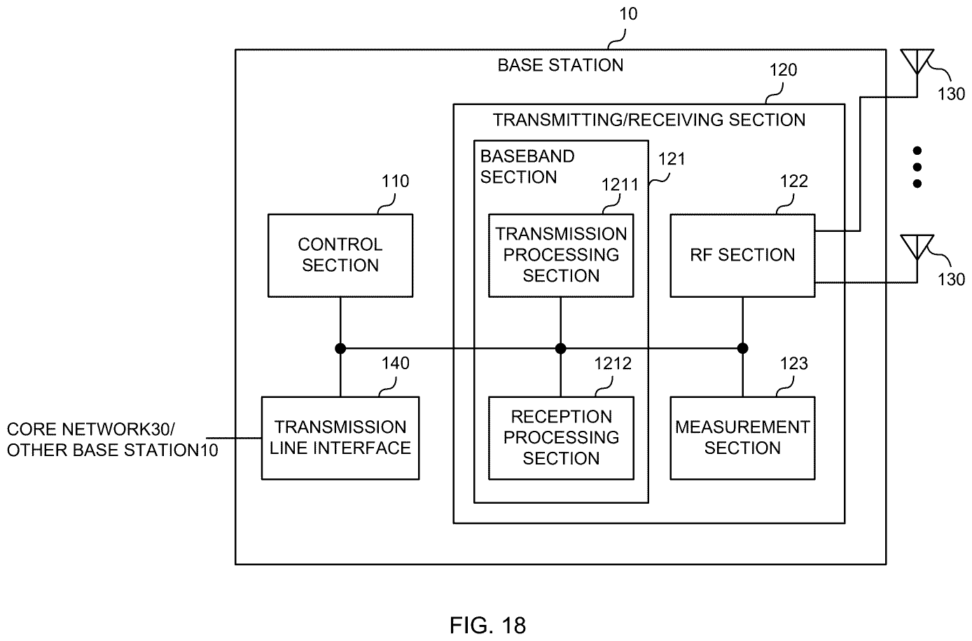

FIG. 18 is a diagram to show an example of a structure of the base station according to one embodiment. The base station 10 includes a control section 110, a transmitting/receiving section 120, transmitting/receiving antennas 130 and a transmission line interface 140. Note that the base station 10 may include one or more control sections 110, one or more transmitting/receiving sections 120, one or more transmitting/receiving antennas 130, and one or more transmission line interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the transmission line interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The transmission line interface 140 may perform transmission/reception (backhaul signaling) of a signal with an apparatus (for example, a network node that provides NFs) included in the core network 30, other base stations 10, and so on, and, for example, acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the transmission line interface 140.

The transmitting/receiving section 120 may transmit information related to sounding reference signal (SRS) transmission using a plurality of ports being more than four ports. The control section 110 may control reception of the SRS transmission with at least one of the number of repetitions of the SRS transmission, the number of symbols to which the plurality of ports are mapped, and the number of ports out of the plurality of ports to be mapped to one symbol based on the information.

The transmitting/receiving section 120 may transmit information related to sounding reference signal (SRS) transmission using a plurality of ports being more than four ports. Based on the information, the control section 110 may control reception of the SRS transmission with hopping of a comb offset in the SRS transmission based on the information.

### (User Terminal)

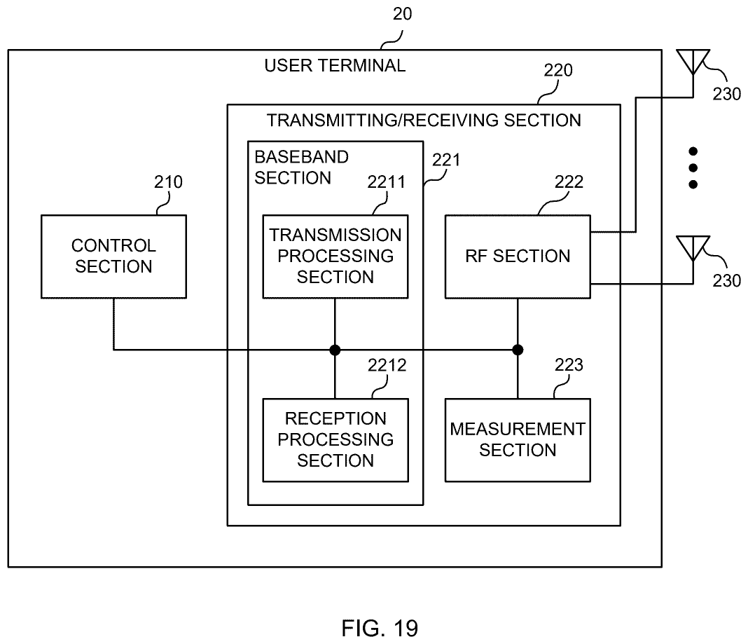

FIG. 19 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission processing.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the measurement section 223 may derive channel measurement for CSI calculation, based on resources for channel measurement. The resources for channel measurement may be non zero power (NZP) CSI-RS resources, for example. The measurement section 223 may derive interference measurement for CSI calculation, based on resources for interference measurement. The resources for interference measurement may be at least one of NZP CSI-RS resources for interference measurement, CSI-interference measurement (IM) resources, and the like. Note that CSI-IM may be referred to as CSI-interference management (IM), or may be interchangeably interpreted as a zero power (ZP) CSI-RS. Note that, in the present disclosure, a CSI-RS, an NZP CSI-RS, a ZP CSI-RS, CSI-IM, a CSI-SSB, and the like may be interchangeably interpreted.

Note that the transmitting section and the receiving section of the user terminal 20 in the present disclosure may be constituted with at least one of the transmitting/receiving section 220 and the transmitting/receiving antennas 230.

The transmitting/receiving section 220 may receive information related to sounding reference signal (SRS) transmission using a plurality of ports being more than four ports. The control section 210 may determine at least one of the number of repetitions of the SRS transmission, the number of symbols to which the plurality of ports are mapped, and the number of ports out of the plurality of ports to be mapped to one symbol, based on the information.

The number of repetitions may be limited as compared to a case in which four or less ports are used.

The control section may determine at least one of the number of symbols and the number of ports, based on the number of repetitions.

The information may indicate at least one of the number of symbols and the number of ports.

The transmitting/receiving section 220 may receive information related to sounding reference signal (SRS) transmission using a plurality of ports being more than four ports. The control section 210 may control hopping of a comb offset in the SRS transmission, based on the information.

The control section may perform the hopping for each granularity of at least one of a symbol, a plurality of symbols to which the plurality of ports are mapped, and the symbols of the number of repetitions of the SRS transmission.

The information may indicate granularity of at least one of a symbol, a plurality of symbols to which the plurality of ports are mapped, and the symbols of the number of repetitions of the SRS transmission.

Use of the plurality of ports being more than four ports and the hopping may not be simultaneously configured.

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate apparatuses (for example, via wire, wireless, or the like) and using these apparatuses. The functional blocks may be implemented by combining software into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but functions are by no means limited to these. For example, a functional block (component) to implement a function of transmission may be referred to as a “transmitting section (transmitting unit)”, a “transmitter”, or the like. The method for implementing each component is not particularly limited as described above.

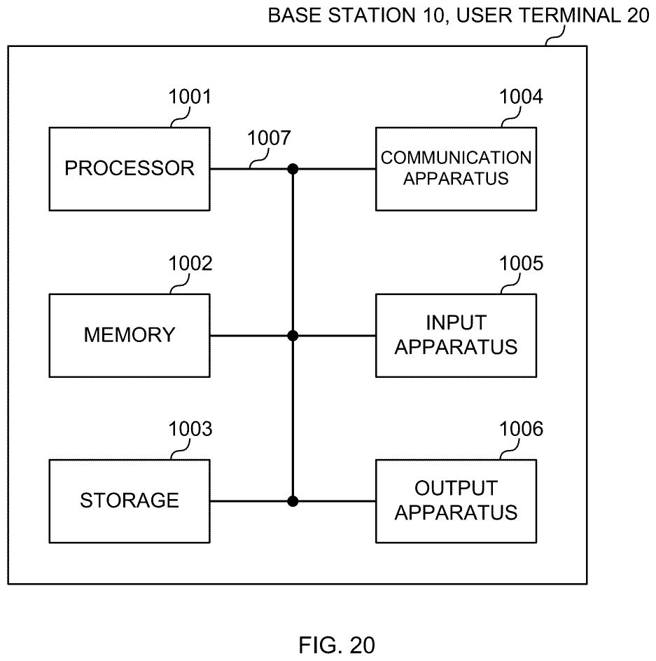

For example, a base station, a user terminal, and so on according to one embodiment of the present disclosure may function as a computer that executes the processes of the radio communication method of the present disclosure. FIG. 20 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably used. The hardware structure of the base station 10 and the user terminal 20 may be configured to include one or more of apparatuses shown in the drawings, or may be configured not to include part of apparatuses.

For example, although one processor 1001 is shown in the drawings, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminal 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least a part of the control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least a part of the operations explained in the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register”, a “cache”, a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “auxiliary storage apparatus”.

The communication apparatus 1004 is hardware (transmitting/receiving device) for allowing inter-computer communication via at least one of wired and wireless networks, and may be referred to as, for example, a “network device”, a “network controller”, a “network card”, a “communication module”, and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the transmitting/receiving section 120 (220), the transmitting/receiving antenna 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor or the like). The output apparatus 1006 is an output device that allows sending output to the outside (for example, a display, a speaker, a Light Emitting Diode (LED) lamp or the like). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between apparatuses.

Also, the base station 10 and the user terminal 20 may be structured to include hardware such as a microprocessor, a Digital Signal Processor (DSP), an Application Specific Integrated Circuit (ASIC), a Programmable Logic Device (PLD), a Field Programmable Gate Array (FPGA), and so on, and a part or all of the functional blocks may be implemented by the hardware. For example, the processor 1001 may be implemented with at least one of these pieces of hardware.

### (Variations)

It should be noted that a term used in the present disclosure and a term required for understanding of the present disclosure may be replaced by a term having the same or similar meaning. For example, a channel, a symbol, and a signal (or signaling) may be interchangeably used. Further, a signal may be a message. A reference signal may be abbreviated as an RS, and may be referred to as a pilot, a pilot signal or the like, depending on which standard applies. Furthermore, a component carrier (CC) may be referred to as a cell, a frequency carrier, a carrier frequency and so on.

A radio frame may be constituted of one or a plurality of periods (frames) in the time domain. Each of one or a plurality of periods (frames) constituting a radio frame may be referred to as a “subframe”. Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot”. A mini-slot may be constituted of symbols in number less than the slot. A PDSCH (or PUSCH) transmitted in a time unit larger than a mini-slot may be referred to as “PDSCH (PUSCH) mapping type A”. A PDSCH (or PUSCH) transmitted using a mini-slot may be referred to as “PDSCH (PUSCH) mapping type B”.

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably used.

For example, one subframe may be referred to as a “TTI”, a plurality of consecutive subframes may be referred to as a “TTI”, or one slot or one mini-slot may be referred to as a “TTI”. In other words, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot”, a “mini-slot”, or the like, instead of a “subframe”.

Here, a TTI refers to the minimum time unit of scheduling in radio communication, for example. For example, in LTE systems, a base station performs, for user terminals, scheduling of allocating of radio resources (such as a frequency bandwidth and transmit power that are available for each user terminal) in TTI units. Note that the definition of TTIs is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI”, a “normal subframe”, a “long subframe”, a “slot” and so on. A TTI that is shorter than a normal TTI may be referred to as a “shortened TTI”, a “short TTI”, a “partial or fractional TTI”, a “shortened subframe”, a “short subframe”, a “mini-slot”, a “sub-slot”, a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB))”, a “sub-carrier group (SCG)”, a “resource element group (REG)”, a “PRB pair”, an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth”, and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a UE may not need to assume to transmit/receive a certain signal/channel outside the active BWP(s). Note that a “cell”, a “carrier”, and so on in the present disclosure may be used interchangeably with a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Further, the information, parameters, and so on described in the present disclosure may be expressed using absolute values or relative values with respect to certain values, or may be expressed using another corresponding information. For example, a radio resource may be specified by a certain index.

The names used for parameters and so on in the present disclosure are in no respect used as limitations. Furthermore, mathematical expressions that use these parameters, and so on may be different from those explicitly disclosed in the present disclosure. Since various channels (PUCCH, PDCCH, and so on) and information elements may be identified by any suitable names, the various names allocated to these various channels and information elements are in no respect used as limitations.

The information, signals, and so on described in the present disclosure may be represented by using any of a variety of different technologies. For example, data, an instruction, a command, information, a signal, a bit, a symbol, a chip, and so on, described throughout the description of the present application, may be represented by a voltage, an electric current, electromagnetic waves, magnetic fields, a magnetic particle, optical fields, a photon, or any combination thereof.

Also, information, signals, and so on can be output at least one of from a higher layer to a lower layer and from a lower layer to a higher layer. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or added. The information, signals, and so on that has been output may be deleted. The information, signals, and so on that has been input may be transmitted to another apparatus.

Notification of information is by no means limited to the aspects/embodiments described in the present disclosure, and other methods may be used as well. For example, notification of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information block (SIB), and so on), Medium Access Control (MAC) signaling and so on), and other signals or combinations of these.

Note that physical layer signaling may be referred to as “Layer 1/Layer 2 (L1/L2) control information (L1/L2 control signals)”, “L1 control information (L1 control signal)”, and so on. Also, RRC signaling may be referred to as an “RRC message”, and can be, for example, an RRC connection setup message, an RRC connection reconfiguration message, and so on. Also, MAC signaling may be notified using, for example, MAC control elements (MAC CEs).

Also, notification of certain information (for example, notification of “X”) does not necessarily have to be performed explicitly, and can be performed implicitly (by, for example, not reporting this certain information or reporting another piece of information).

A decision may be realized by a value (0 or 1) represented by one bit, by a boolean value (true or false), or by comparison of numerical values (e.g., comparison with a certain value).

Software, irrespective of whether referred to as “software” “firmware”, “middleware”, “microcode”, or “hardware description language”, or called by other terms, should be interpreted broadly to mean instructions, instruction sets, codes, code segments, program codes, programs, subprograms, software modules, applications, software applications, software packages, routines, subroutines, objects, executable files, execution threads, procedures, functions, and the like.

Also, software, instructions, information, and the like may be transmitted and received via a transmission medium. For example, when software is transmitted from a website, a server, or other remote sources by using at least one of wired technologies (coaxial cable, fiber optic cable, twisted-pair cable, digital subscriber line (DSL), and so on) and wireless technologies (infrared radiation, microwaves, and so on), at least one of these wired technologies and wireless technologies is also included in the definition of the transmission medium.

The terms “system” and “network” used in the present disclosure may be used interchangeably. The “network” may mean an apparatus (for example, a base station) included in the network.

In the present disclosure, the terms such as “precoding”, a “precoder”, a “weight (precoding weight)”, “quasi-co-location (QCL)”, a “Transmission Configuration Indication state (TCI state)”, a “spatial relation”, a “spatial domain filter”, a “transmit power”, “phase rotation”, an “antenna port”, a “layer”, “the number of layers”, a “rank”, a “resource”, a “resource set”, a “beam”, a “beam width”, a “beam angular degree”, an “antenna”, an “antenna element”, a “panel”, a “UE panel”, a “transmission entity”, a “reception entity”, and so on may be used interchangeably.

Note that, in the present disclosure, the “antenna port” may be used interchangeably with an “antenna port for an arbitrary signal/channel” (for example, a demodulation reference signal (DMRS) port). In the present disclosure, the “resource” may be used interchangeably with a “resource for an arbitrary signal/channel” (e.g., a reference signal resource, an SRS resource, and the like). The resource may include time/frequency/code/space/power resource. The spatial domain transmission filter may include at least one of a spatial domain transmission filter and a spatial domain reception filter.

The group may include at least one of, for example, a spatial relationship group, a code division multiplexing (CDM) group, a reference signal (RS) group, a control resource set (CORESET) group, a PUCCH group, an antenna port group (for example, a DMRS port group), a layer group, a resource group, a beam group, an antenna group, a panel group, and the like.

In the present disclosure, a “beam”, an “SRS resource indicator (SRI)”, a “CORESET”, a “CORESET pool”, a “PDSCH”, a “PUSCH”, a “codeword (CW)”, a “transport block (TB)”, an “RS”, and the like may be interchangeably used.

In the present disclosure, a “TCI state”, a “downlink TCI state (DL TCI state)”, an “uplink TCI state (UL TCI state)”, a “unified TCI state”, a “common TCI state”, a “joint TCI state”, and the like may be used interchangeably.

In the present disclosure, “QCL”, “QCL assumption”, “QCL relationship”, “QCL type information”, “QCL property/properties”, “specific QCL type (e.g., type A, type D) property”, “specific QCL type (e.g., type A, type D)”, and the like may be used interchangeably.

In the present disclosure, an “index”, an “identifier (ID)”, an “indicator”, “indication”, a “resource ID”, and the like may be used interchangeably. In the present disclosure, a sequence, a list, a set, a group, a cluster, a subset, and the like may be used interchangeably.

A spatial relation information identifier (ID) (TCI state ID) and spatial relation information (TCI state) may be interchangeably used. “Spatial relation information (TCI state)” may be used interchangeably with “a set of spatial relation information (TCI state)”, “one or a plurality of spatial relation information”, and the like. The TCI state and the TCI may be used interchangeably. The spatial relation information and the spatial relation may be used interchangeably.

In the present disclosure, the terms such as a “base station (BS)”, a “radio base station”, a “fixed station,” a “NodeB”, an “eNB (eNodeB)”, a “gNB (gNodeB)”, an “access point”, a “transmission point (TP)”, a “reception point (RP)”, a “transmission/reception point (TRP)”, a “panel”, a “cell”, a “sector”, a “cell group”, a “carrier”, a “component carrier”, and so on can be used interchangeably. The base station may be referred to as the terms such as a “macro cell”, a “small cell”, a “femto cell”, a “pico cell”, and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, transmitting information to the terminal by the base station may be interchangeably interpreted as instructing the terminal to perform control/operation based on the information by the base station.

In the present disclosure, the terms “mobile station (MS)”, “user terminal”, “user equipment (UE)”, and “terminal” may be used interchangeably.

A mobile station may be referred to as a “subscriber station”, “mobile unit”, “subscriber unit”, “wireless unit”, “remote unit”, “mobile device”, “wireless device”, “wireless communication device”, “remote device”, “mobile subscriber station”, “access terminal”, “mobile terminal”, “wireless terminal”, “remote terminal”, “handset”, “user agent”, “mobile client”, “client”, or some other appropriate terms in some cases.

At least one of a base station and a mobile station may be referred to as a “transmitting apparatus”, a “receiving apparatus”, a “radio communication apparatus” or the like. Note that at least one of a base station and a mobile station may be a device mounted on a moving object or a moving object itself, and so on.

The moving object is a movable object with any moving speed, and naturally, it also includes a moving object stopped. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

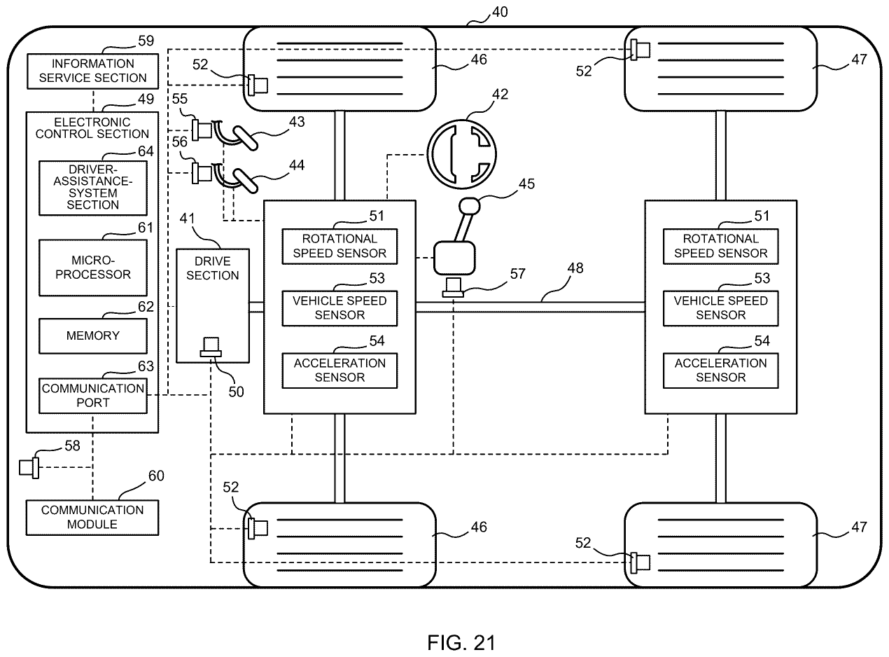

FIG. 21 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 includes at least a steering wheel (also referred to as a handle), and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 provided in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes: various devices for providing (outputting) various pieces of information such as driving information, traffic information, and entertainment information, such as a car navigation system, an audio system, a speaker, a display, a television, and a radio; and one or more ECUs that control these devices. The information service section 59 provides various pieces of information/services (for example, multimedia information/multimedia service) to an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes: various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor; and one or more ECUs that control these devices. The driving assistance system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, the communication module 60 transmits and receives data (information), via the communication port 63, to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 is a communication device that can be controlled by the microprocessor 61 of the electronic control section 49 and that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals input from the various sensors 50 to 58 to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the received information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may control the driving section 41, the steering section 42, the accelerator pedal 43, the brake pedal 44, the shift lever 45, the right and left front wheels 46, the right and left rear wheels 47, the axle 48, the various sensors 50 to 58, and the like provided in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D)”, “Vehicle-to-Everything (V2X)”, and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as a base station. In this case, the base station 10 may have the functions of the user terminal 20 described above.

Operations which have been described in the present disclosure to be performed by a base station may, in some cases, be performed by an upper node of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

Each aspect/embodiment described in the present disclosure may be used independently, may be used in combination, or may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced, modified, created, or defined based on these. A plurality of systems may be combined (for example, a combination of LTE or LTE-A and 5G, and the like) for application.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first”, “second”, and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “deciding (determining)” as in the present disclosure herein may encompass a wide variety of actions. For example, “deciding (determining)” may be interpreted to mean making “decisions (determinations)” about judging, calculating, computing, processing, deriving, investigating, looking up, search and inquiry (for example, searching a table, a database, or some other data structures), ascertaining, and so on.

Furthermore, “deciding (determining)” may be interpreted to mean making “decisions (determinations)” about receiving (for example, receiving information), transmitting (for example, transmitting information), input, output, accessing (for example, accessing data in a memory), and so on.

In addition, “deciding (determining)” as used herein may be interpreted to mean making “decisions (determinations)” about resolving, selecting, choosing, establishing, comparing, and so on. In other words, “deciding (determining)” may be interpreted to mean making “decisions (determinations)” about some action. In the present disclosure, “decide/deciding (determine/determining)” may be interchangeably interpreted as the above-described actions.

In the present disclosure, “decide/deciding (determine/determining)” may be used interchangeably with “assume/assuming”, “expect/expecting”, “consider/considering”, and the like. Note that, in the present disclosure, “not expect to” may be used interchangeably with “expect not to”.

In the present disclosure, “expect” may be used interchangeably with “be expected”. For example, “expect(s) . . . ” (“ . . . ” may be expressed using, for example, a that-clause, a to-infinitive, or the like) may be used interchangeably with “be expected . . . ”. “Does not expect . . . ” may be used interchangeably with “be not expected . . . ”. Furthermore, “an apparatus A is not expected . . . ” may be used interchangeably with “an apparatus B other than the apparatus A does not expect . . . for the apparatus A” (for example, when the apparatus A is a UE, the apparatus B may be a base station).

“The maximum transmit power” described in the present disclosure may mean a maximum value of the transmit power, may mean the nominal maximum transmit power (the nominal UE maximum transmit power), or may mean the rated maximum transmit power (the rated UE maximum transmit power).

The terms “connected”, “coupled”, or any variation of these terms as used in the present disclosure mean any direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access”.

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other”. It should be noted that the phrase may mean that “A and B are each different from C”. The terms “separate”, “coupled”, and so on may be interpreted similarly to “different”.

In the case where the terms “include”, “including”, and variations thereof are used in the present disclosure, these terms are intended to be comprehensive, in a manner similar to the term “comprising”. Furthermore, the term “or” used in the present disclosure is not intended to be an “exclusive or”.

For example, in the present disclosure, where an article such as “a”, “an”, and “the” is added by translation, the present disclosure may include that a noun after the article is in a plural form.

In the present disclosure, “equal to or less than”, “less than”, “equal to or more than”, “more than”, “equal to”, and the like may be used interchangeably. In the present disclosure, words such as “good”, “bad”, “large”, “small”, “high”, “low”, “early”, “late”, “wide”, “narrow”, and the like may be used interchangeably irrespective of positive degree, comparative degree, and superlative degree. In the present disclosure, expressions obtained by adding “i-th” (i is any integer) to words such as “good”, “bad”, “large”, “small”, “high”, “low”, “early”, “late”, “wide”, “narrow”, and the like may be used interchangeably irrespective of positive degree, comparative degree, and superlative degree (for example, “best” may be used interchangeably with “i-th best”, and vice versa).

In the present disclosure, “of”, “for”, “regarding”, “related to”, “associated with”, and the like may be used interchangeably.

In the present disclosure, “when A, B”, “if A, (then) B”, “B upon A”, “B in response to A”, “B based on A”, “B during/while A”, “B before A”, “B (at the same time as)/on A”, “B after A”, “B since A”, “B until A”, and the like may be used interchangeably. Note that A and B here may be replaced with appropriate expressions such as nouns, dynamic nouns, and normal sentences, as appropriate, depending on the context. The time difference between A and B may be substantially 0 (immediately after or immediately before). A time offset may be applied to the time at which A occurs. For example, “A” may be used interchangeably with “before/after the time offset at which A occurs”. The time offset (for example, one or more symbols/slots) may be defined in advance or may be specified by the UE based on the notified information.

In the present disclosure, timing, time point, time, time instance, any time unit (e.g., slot, sub-slot, symbol, subframe), period, occasion, a resource, or the like may be used interchangeably.

Now, although the invention according to the present disclosure has been described in detail above, it is apparent to a person skilled in the art that the invention according to the present disclosure is by no means limited to the embodiments described in the present disclosure. The description of the present disclosure is provided only for the purpose of explaining examples, and should by no means be construed to limit the invention according to the present disclosure in any way.

1. A terminal comprising:
a receiving section that receives information related to sounding reference signal (SRS) transmission using a plurality of ports being more than four ports; and
a control section that determines, based on the information, at least one of a number of repetitions of the SRS transmission, a number of symbols to which the plurality of ports are mapped, and a number of ports out of the plurality of ports to be mapped to one symbol.

2. The terminal according to claim 1, wherein
the number of repetitions is limited as compared to a case in which four or less ports are used.

3. The terminal according to claim 1, wherein
the control section determines at least one of the number of symbols and the number of ports, based on the number of repetitions.

4. The terminal according to claim 1, wherein
the information indicates at least one of the number of symbols and the number of ports.

5. A radio communication method for a terminal, comprising:
receiving information related to sounding reference signal (SRS) transmission using a plurality of ports being more than four ports; and
determining, based on the information, at least one of a number of repetitions of the SRS transmission, a number of symbols to which the plurality of ports are mapped, and a number of ports out of the plurality of ports to be mapped to one symbol.

6. A base station comprising:
a transmitting section that transmits information related to sounding reference signal (SRS) transmission using a plurality of ports being more than four ports; and
a control section that controls reception of the SRS transmission with at least one of a number of repetitions of the SRS transmission, a number of symbols to which the plurality of ports are mapped, and a number of ports out of the plurality of ports to be mapped to one symbol based on the information.
